(19) United States
(12) Patent Application Publication
(10) Pub. No.: US 2026/0003361 A1
(43) Pub. Date: Jan. 1, 2026

(54) AUTONOMOUS WORKING ROBOT AND SYSTEM

(71) Applicant: Positec Power Tools (Suzhou) Co., Ltd, Jiangsu (CN)

(72) Inventors: Meng WENG, Suzhou (CN); Shengcang YANG, Suzhou (CN); Zhiguo REN, Suzhou (CN); Xiahong Zha, Suzhou (CN); Bincai LAN, Suzhou (CN); Xinglong HOU, Suzhou (CN); Xiaohui ZHOU, Suzhou (CN); Siyuan ZHENG, Suzhou (CN); Hang YU, Suzhou (CN); Shuailong LU, Suzhou (CN)

(21) Appl. No.: 18/917,922

(22) Filed: Oct. 16, 2024

Related U.S. Application Data
(63) Continuation-in-part of application No. PCT/CN2023/108919, filed on Jul. 24, 2023.

(30) Foreign Application Priority Data
Jun. 28, 2024 (CN) CN20241085434.4
Sep. 20, 2024 (CN) CN202411319950.0

(51) Int. Cl. G05D 1/43

(52) U.S. Cl. CPC G05D 1/43

(57) ABSTRACT

An autonomous working robot including a sensor assembly configured to generate sensing data based on acquired information; and a controller configured to determine whether an entry condition is met, and perform an entry control process in response to the entry condition being met. The entry control process includes outputting a corresponding driving instruction according to the sensing data to control a first movement trajectory of the autonomous working robot moving from a vehicle transporting the autonomous working robot to a ground of a non-working area; obtaining map data of a working area of a working task to be performed; and outputting a corresponding driving instruction according to the map data and sensing data to control a second movement trajectory of the autonomous working robot moving from the ground of the non-working area to the working area.

This application is a Continuation-in-part Application of Chinese Patent Application No. CN20241085434.4 filed on Jun. 28, 2024, Chinese Patent Application No. CN202411319950.0 filed on Sep. 20, 2024, and PCT Application No PCT/CN2023/108919 filed on Jul. 24, 2023 which claims the benefit of and priority to Chinese Patent Application No. CN202210870782.9, filed on Jul. 22, 2022, all of which are hereby incorporated by reference in their entireties for all purposes as if fully set forth herein.

### TECHNICAL FIELD

The present disclosure relates to the field of autonomous working robot technologies, and, more particularly, to an autonomous working robot, an autonomous working system, and a control method.

### BACKGROUND

For a commercial team that provides related services, a transport vehicle needs to be used to transport an autonomous working robot that provides related services to a parking point near a working area, so that after the autonomous working robot autonomously moves to a get-off point from the transport vehicle, the get-off point is directly located in the working area. In this way, after getting off, the autonomous working robot can directly perform a working task in the working area. However, in some scenarios (for example, an obstacle is present near a working area), the transport vehicle cannot park near a working area. In this case, after the autonomous working robot moves from the transport vehicle to the get-off point on a ground, the get-off point is located in a non-working area. In this case, a worker further needs to carry the autonomous working robot from the get-off point to the working area. As a result, the autonomous working robot excessively depends on manual labor, and the level of automation is not high enough.

For example, the autonomous working robot is an autonomous lawn mower. In some users' homes, a road nearby does not allow easy passage of the transport vehicle. In this case, the transport vehicle cannot travel near a user's lawn. In this case, after the autonomous lawn mower autonomously moves to a get-off point from the transport vehicle, the get-off point is located in a non-working area. The non-working area has a distance from a working area. This distance can only depend on manual carrying, and as a result the level of automation of the autonomous working robot is not high enough.

### SUMMARY

In view of this, embodiments of the present disclosure are intended to provide an autonomous working robot, an autonomous working system, and a control method. Several aspects of this application are mainly described below.

According to a first aspect, an autonomous working robot is provided, and includes: a body; a driving assembly, connected to the body, and configured to drive the autonomous working robot to move according to a driving instruction; a sensor assembly, configured to generate sensing data based on acquired information; and a controller, configured to: determine whether an entry condition is met; and perform an entry control process in response to the entry condition being met, where the entry control process includes: outputting a corresponding driving instruction according to the sensing data, to control a first movement trajectory of the autonomous working robot moving from a vehicle transporting the autonomous working robot to a ground of a non-working area; obtaining map data of a working area of a working task to be performed; and outputting a corresponding driving instruction according to the map data and sensing data, to control a second movement trajectory of the autonomous working robot moving from the ground of the non-working area to the working area.

According to a second aspect, an autonomous working robot is provided, and includes: a body; a driving assembly, connected to the body, and configured to drive the autonomous working robot to move according to a driving instruction; a sensor assembly, configured to generate sensing data based on acquired information, where the sensing data includes positioning data used for indicating position information of the autonomous working robot; and a controller, configured to: determine whether a first condition is met; perform a departure control process in response to the first condition being met, to control the autonomous working robot to go to a target position from a current starting position, at least one of the starting position and the target position being located outside a working area, where the departure control process includes: determining, according to the sensing data, whether a preset event occurs in the autonomous working robot, and if yes, recording position data of at least one position of the autonomous working robot in a movement process in response to the occurrence of the preset event according to the positioning data in the sensing data, where the position data includes starting position data used for indicating position information of the starting position; determine whether a second condition is met; and perform a return control process in response to the second condition being met, to control the autonomous working robot to return from the target position to the starting position, where the return control process includes: controlling the autonomous working robot according to the starting position data to pass through the at least one position to return to the starting position.

According to a third aspect, an autonomous working system is provided. In some embodiments, the system includes: the autonomous working robot according to the first aspect or the second aspect; a terminal, communicatively connected to the autonomous working robot; and a server, communicatively connected to the autonomous working robot and the terminal, and configured to store map data of different working areas, to send the map data of the working areas to the autonomous working robot and/or the terminal in the entry control process.

According to a fourth aspect, a control method of an autonomous working robot is provided. The autonomous working robot includes a body, a sensor assembly, a driving assembly, and a controller. The driving assembly is connected to the body. The driving assembly is configured to drive the autonomous working robot to move according to a driving instruction. The sensor assembly is configured to generate sensing data based on acquired information. The controller is configured to: determine whether an entry condition is met; and perform an entry control process in response to the entry condition being met, where the entry control process includes: outputting a corresponding driving instruction according to the sensing data, to control a first movement trajectory of the autonomous working robot moving from a vehicle transporting the autonomous working robot to a ground of a non-working area; obtaining map data of a working area of a working task to be performed; and outputting a corresponding driving instruction according to the map data and sensing data, to control a second movement trajectory of the autonomous working robot moving from the ground of the non-working area to the working area.

In the embodiments of this application, the controller in the autonomous working robot performs a control process, outputs a corresponding driving instruction based on the sensing data to control the first movement trajectory of the autonomous working robot moving from the vehicle transporting the autonomous working robot to the ground of the non-working area, and outputs a corresponding driving instruction according to the map data and sensing data in some embodiments, to control the second movement trajectory of the autonomous working robot moving from the ground of the non-working area to the working area, so that the autonomous working robot can autonomously move from a transport vehicle to the working area along the first movement trajectory and the second movement trajectory. In this way, a case when the transport vehicle cannot park near the working area, a worker needs to carry the autonomous working robot from a get-off point of the transport vehicle to the working area is avoided, which helps to improve the level of automation of the autonomous working robot.

In another aspect, in some embodiments, the controller in the autonomous working robot controls, based on the sensing data, the first movement trajectory of the autonomous working robot moving from the transport vehicle to the non-working area, and controls, based on the map data and the sensing data, the second movement trajectory of the autonomous working robot moving from the non-working area to the working area, thereby helping to improve the accuracy of controlling the first movement trajectory and the second movement trajectory by the controller, or in other words, helping to improve the accuracy of controlling an entry movement trajectory of the autonomous working robot by the controller.

According to a fifth aspect, an autonomous working robot is provided, suitable for performing at least one working task on a surface of a working area, and including: a driving assembly, configured to drive the autonomous working robot to move according to a driving instruction; a sensor assembly, configured to generate sensing data based on acquired information, where the sensing data includes positioning data used for indicating position information of the autonomous working robot; and a controller, communicatively connected to the driving assembly and the sensor assembly, and configured to: at least perform a control process: receiving an input of the sensing data; and controlling movement of the autonomous working robot outside a working area according to the sensing data, and further at least perform a navigation process: obtaining preset map data of a working area of a working task to be performed; and controlling, according to the sensing data and the map data, a movement trajectory of the autonomous working robot moving to the working area, where the map data includes boundary data of the working area and guidance data used for guiding the autonomous working robot to move to the working area.

According to a sixth aspect, a control method of an autonomous working robot is provided. The autonomous working robot is configured to perform at least one working task on a surface of a working area. The method includes: performing a control operation: receiving sensing data from a sensor assembly, where the sensing data includes positioning data used for indicating position information of the autonomous working robot; and controlling movement of the autonomous working robot outside a working area according to the sensing data; and further performing a navigation operation: obtaining preset map data of a working area of a working task to be performed, where the map data includes boundary data of the working area and guidance data used for guiding the autonomous working robot to move to the working area; and controlling, according to the sensing data and the map data, a movement trajectory of the autonomous working robot moving to the working area.

According to a seventh aspect, an autonomous working system is provided. The autonomous working system includes: the autonomous working robot according to the first aspect; and a server, configured to provide map data of a working area to the autonomous working robot.

According to an eighth aspect, a computer-readable storage medium is provided, having executable code stored thereon. When the executable code is executed, the method according to the fourth aspect or the sixth aspect can be implemented.

According to a ninth aspect, a computer program product is provided, including executable code. When the executable code is executed, the method according to the fourth aspect or the sixth aspect can be implemented.

In the embodiments of the present disclosure, the autonomous working robot is controlled according to the map data of the working area of the working task to be performed to automatically move from outside a working area to the working area in some embodiments, so that the problem that the autonomous working robot needs to be manually operated to move from outside the working area to the working area can be resolved.

The map data in the embodiments of the present disclosure includes preset guidance data used for guiding the autonomous working robot to move to the working area, so that the guidance data can be used to quickly control the autonomous working robot to move to the working area. The presence of the guidance data helps to guide the autonomous working robot to effectively avoid a surrounding obstacle, and therefore is applicable to a scenario with a number of surrounding obstacles or a complex landform.

The autonomous working robot in the embodiments of the present disclosure uses the preset guidance data to enter the working area in some embodiments, so that it is not necessary to set more path planning algorithms for the autonomous working robot, a data processing requirement of the autonomous working robot is low, and costs can be reduced to a certain degree.

### BRIEF DESCRIPTION OF THE DRAWINGS

FIG. 1 is a schematic diagram of a transport vehicle applicable to embodiments of this application;

FIG. 2 is a schematic diagram of an autonomous working robot according to an embodiment of this application;

FIG. 3 is a schematic diagram of a movement path of an autonomous working robot according to an embodiment of this application;

FIG. 4 is a schematic diagram of a movement path of an autonomous working robot according to another embodiment of this application;

FIG. 5 is a schematic diagram of an autonomous working robot according to another embodiment of this application;

FIG. 6 is a schematic diagram of a movement path of an autonomous working robot according to another embodiment of this application;

FIG. 7 is a schematic diagram of an autonomous working system according to an embodiment of this application;

FIG. 8 is a schematic diagram of a control method of an autonomous working robot according to an embodiment of this application;

FIG. 9 is a schematic diagram of a control method of an autonomous working robot according to an embodiment of this application;

FIG. 10 is an exemplary diagram of a control process according to an embodiment of the present disclosure;

FIG. 11 is a schematic structural diagram of an autonomous working robot according to an embodiment of the present disclosure;

FIG. 12 is a schematic flowchart of a navigation process according to an embodiment of the present disclosure;

FIG. 13 is an exemplary diagram of a control process according to another embodiment of the present disclosure;

FIG. 14 is an exemplary diagram of a control process according to still another embodiment of the present disclosure;

FIG. 15 is a schematic structural diagram of an autonomous working system according to an embodiment of the present disclosure;

FIG. 16 is a schematic flowchart of a control method of an autonomous working robot according to an embodiment of the present disclosure;

FIG. 17 is a schematic diagram of entry of an autonomous working robot according to an embodiment of the present disclosure;

FIG. 18 is a schematic diagram of return of a first part of an autonomous working robot according to an embodiment of the present disclosure; and

FIG. 19 is a schematic diagram of return of a second part of an autonomous working robot according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments.

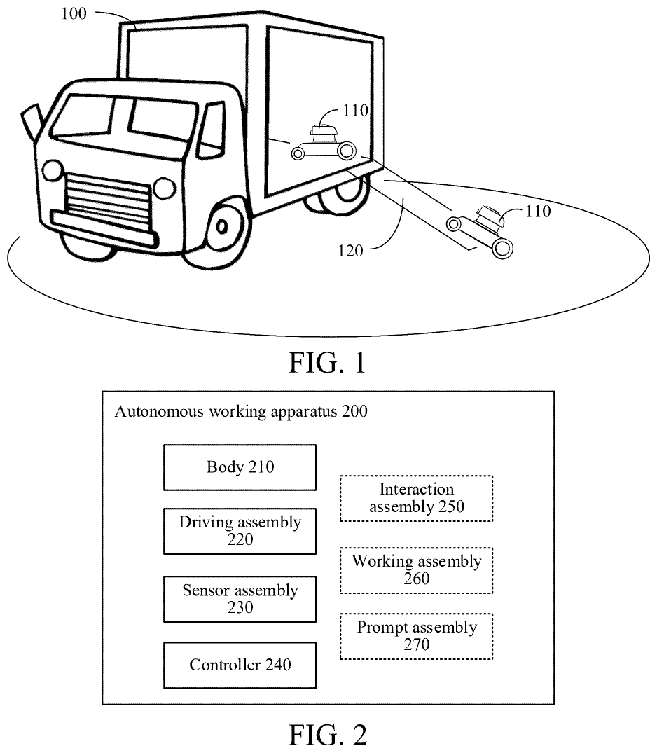

Referring to FIG. 1, a working mode of a conventional commercial team is driving a working transport vehicle 100 to different users' homes according to scheduled orders to work each day. One or more autonomous working robots 110 is/are placed on the transport vehicle 100 in some embodiments. In some implementations, the transport vehicle 100 charges the autonomous working robot 110 in some embodiments.

Usually, the transport vehicle 100 moves near a working area in some embodiments. In this case, a ramp 120 used for loading and unloading the autonomous working robot in the transport vehicle is lowered to allow the autonomous working robot 110 to directly move from the ramp 120 into the working area in some embodiments. It needs to be noted that, the ramp 120 is automatically lowered in some embodiments, or is manually lowered by a worker (or a user) in some embodiments.

In some implementations, the autonomous working robot includes at least one of an autonomous lawn mower, an autonomous snowplow, an autonomous irrigation machine, or an autonomous vacuum cleaner in some embodiments. The autonomous lawn mower is used for lawn maintenance, including, for example, mowing, trimming, and green plant pruning. The autonomous snowplow is used for cleaning snow in a working area. The autonomous irrigation machine is used for irrigating a working area. The autonomous vacuum cleaner is used for cleaning a working area.

As can be learned based on the foregoing description, especially for a commercial team that provides related services, a transport vehicle needs to be used to transport an autonomous working robot that provides related services to a parking point near a working area, so that after the autonomous working robot autonomously moves to a get-off point from the transport vehicle, the get-off point is directly located in the working area. In this way, after getting off, the autonomous working robot directly performs a working task in the working area in some embodiments. However, in some scenarios (for example, an obstacle is present near a working area), the transport vehicle cannot park near a working area. In this case, after the autonomous working robot moves from the transport vehicle to the get-off point on a ground, the get-off point is located in a non-working area. In this case, a worker further needs to perform control and operation to move or carry the autonomous working robot from the get-off point to the working area. As a result, the level of automation is not high enough, and labor costs are increased.

For example, the autonomous working robot is an autonomous lawn mower. In some users' homes, a road near a lawn does not allow easy passage of the transport vehicle. In this case, the transport vehicle cannot automatically travel to a user's lawn. In other words, after the autonomous lawn mower autonomously moves to a get-off point from the transport vehicle, the get-off point is located in the non-working area. The non-working area has a distance from a working area. For this distance, usually the lawn mower can only be manually operated and controlled to move or manually carried, and as a result the level of automation of the autonomous working robot is not high enough.

Therefore, to improve the level of automation of the autonomous working robot, embodiments of this application provide an autonomous working robot. For ease of understanding, the solution provided in the embodiments of this application is described below with reference to the autonomous working robot shown in FIG. 2.

As can be learned from FIG. 2, an autonomous working robot 200 includes a body 210, a driving assembly 220, a sensor assembly 230, and a controller 240 in some embodiments. The driving assembly 220 is connected to the body 210 in some embodiments. The controller 240 is electrically connected to the driving assembly 220 and the sensor assembly 230 in some embodiments.

The driving assembly 220 is configured to drive the autonomous working robot to move according to a driving instruction. In some implementations, the driving assembly is used for driving a walking assembly of the autonomous working robot to move in some embodiments. The walking assembly is, for example, wheels of the autonomous working robot in some embodiments.

The sensor assembly 230 is configured to generate sensing data based on acquired information. In some implementations, the sensor assembly includes, but not limited to, one or more of the following in some embodiments: a positioning sensor, a monocular camera, a multiocular camera, a depth camera, an ultrasonic sensor, an inertial measurement unit, and a laser sensor.

The controller 240 is configured to determine whether an entry condition is met; and perform an entry control process in response to the entry condition being met.

The entry condition is used for determining whether the autonomous working robot can enter the working area. In an implementation, whether the controller receives an external instruction is used for determining whether the entry condition is met in some embodiments. When the controller 240 receives the external instruction, it is determined that the entry condition is met, to perform the entry control process. When the controller 240 does not receive the external instruction, it is determined that the entry condition is not met, and the autonomous working robot remains in a current state.

For example, the entry condition being met is that the controller 240 receives an input of an entry instruction in some embodiments. To be specific, when an external trigger signal is transferred to the controller 240 and the controller 240 receives the trigger signal, it is considered that the autonomous working robot meets the entry condition, to perform the entry control process.

In another implementation, the controller is configured to receive the sensing data, and determine, based on the sensing data, whether the entry condition is met. When the entry condition is met, the controller autonomously generates an entry control signal, and performs the entry control process in response to the entry control signal. In other words, the controller is configured to receive the sensing data, autonomously generate the entry control signal, and perform the entry control process in response to the entry control signal. Specifically, in some embodiments, a condition for the controller to autonomously generate the entry control signal being met includes: the controller detects, based on the sensing data, that a ramp of the vehicle is lowered, and/or the controller detects, based on the sensing data, that the autonomous working robot is in a preset area. Further, in some embodiments, the condition for the controller to autonomously generate the entry control signal being met is that the controller detects, based on the sensing data, that a time for which the autonomous working robot is in the preset area is not less than a preset time, to avoid a case that when the transport vehicle transports the autonomous working robot to the preset area, the autonomous working robot automatically moves before the ramp is deployed, resulting a danger.

For example, in some embodiments, the entry condition being met is that the autonomous working robot recognizes that the time for which the position thereof is in the preset area is not less than the preset time. To be specific, the controller detects, based on the sensing data, whether the time for which the autonomous working robot is in the preset area is not less than the preset time. As discussed above, the vehicle transports the autonomous working robot near the working area. The positioning sensor is disposed on the autonomous working robot to detect position data of the autonomous working robot, and the position data is transferred to the controller 240. When recognizing, based on the position data, that the autonomous working robot has been transported to the preset area, the controller starts to calculate the time for which the autonomous working robot is in the preset area. After the calculated time for which the autonomous working robot is in the preset area reaches the preset time, it is determined that the autonomous working robot meets the entry condition, to perform the entry control process. It needs to be noted that, the autonomous working robot downloads (or invokes) map data from a cloud in advance based on an arrangement order of working tasks, and stores the same in a local memory of the autonomous working robot in some embodiments. The preset area is defined in the map data in some embodiments. It further needs to be noted that, the preset time is set by a user in some embodiments, is not limited, and is specifically freely set based on a road traffic condition near the preset area in some embodiments. In another feasible implementation, the positioning sensor is disposed on the transport vehicle and detects position data of the transport vehicle in some embodiments. The autonomous working robot can perform information interaction with the transport vehicle to obtain the position data of the transport vehicle from the transport vehicle. The position data of the transport vehicle is considered as the position data of the autonomous working robot in some embodiments. In this way, the problem that positioning is inaccurate because the autonomous working robot is inside the transport vehicle is resolved.

For example, the entry condition being met is that the autonomous working robot detects that the ramp of the vehicle is lowered in some embodiments. To be specific, the controller detects, based on the sensing data, that the ramp of the vehicle is lowered. It needs to be noted that, the autonomous working robot moves from inside the vehicle to the non-working area outside the vehicle through the ramp placed on the vehicle. As discussed above, the sensor assembly 230 is disposed on the autonomous working robot. The autonomous working robot recognizes the ramp of the vehicle through one or more of a monocular camera, a multiocular camera, a depth camera, and an ultrasonic sensor (certainly, the sensor in this embodiment is not limited to the foregoing types of sensors, provided that a sensor can recognize a ramp) in some embodiments. The sensor assembly 230 transfers a recognition result to the controller 240. The controller determines, through the recognition result, whether the ramp of the vehicle is lowered. When a determination result is that the ramp of the vehicle is lowered, it is considered that the autonomous working robot meets the entry condition, to perform the entry control process.

In this embodiment, an example in which the entry condition is receiving the entry instruction is used to describe the entry control process. The controller 240 is configured to receive an input of an entry instruction; and perform an entry control process in response to the entry instruction. In other embodiments, the entry control process performed by the controller after another entry condition is met is approximately the same. Details are not described here again.

The entry control process includes: outputting a corresponding driving instruction according to the sensing data generated by the sensor assembly, to control a first movement trajectory of the autonomous working robot moving from the vehicle transporting the autonomous working robot to a ground of the non-working area. Further, the entry control process further includes: obtaining map data of a working area of a working task to be performed; and outputting a corresponding driving instruction according to the map data and sensing data, to control a second movement trajectory of the autonomous working robot moving from the ground of the non-working area to the working area.

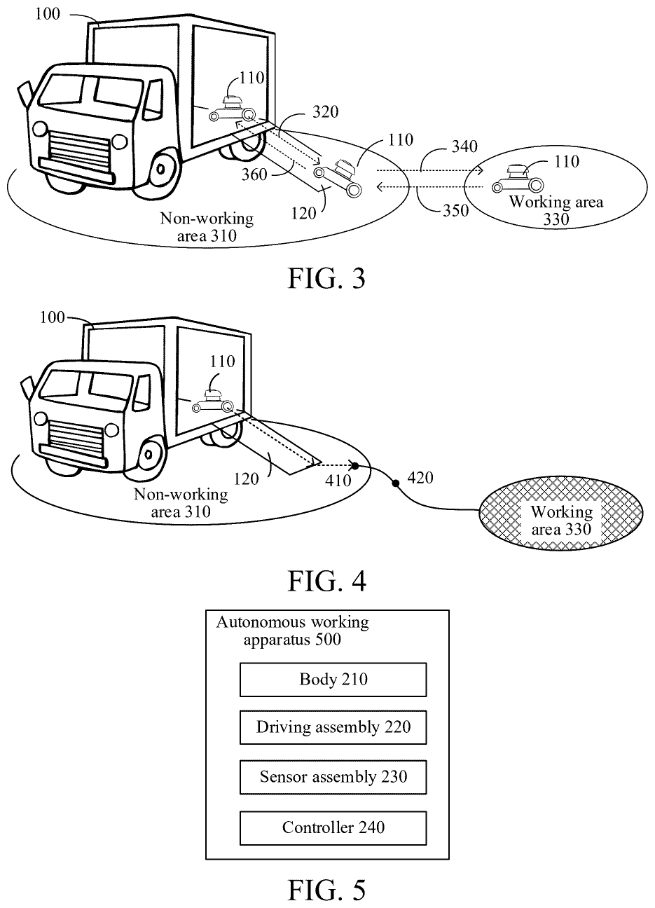

For ease of understanding, a movement path of the autonomous working robot in an entry control process is described below with reference to FIG. 3. Referring to FIG. 3, the controller outputs a corresponding driving instruction according to the sensing data in some embodiments, to control a first movement trajectory 320 of the autonomous working robot 110 moving from the transport vehicle 100 to the ground of the non-working area 310. In some embodiments, the controller obtains map data of a working area of a working task to be performed; and outputs a corresponding driving instruction according to the map data and sensing data, to continue to control a second movement trajectory 340 of the autonomous working robot 110 moving from the ground of the non-working area 310 to a working area 330.

The entry instruction is used for indicating the autonomous working robot to enter the working area. In some implementations, the entry instruction is triggered by a worker in some embodiments, for example, is triggered by the worker to the autonomous working robot through a terminal device (for example, a mobile phone) in some embodiments. In another example, an input apparatus (for example, a button) for inputting the entry instruction is disposed on the autonomous working robot in some embodiments. Correspondingly, the worker inputs the entry instruction to the autonomous working robot through the input apparatus in some embodiments.

In some implementations, the obtaining map data of a working area of a working task to be performed includes obtaining the map data from a storage apparatus of the autonomous working robot in some embodiments. For example, the autonomous working robot downloads (or invokes) map data from a cloud in advance based on an arrangement order of working tasks, and stores the same in a local memory of the autonomous working robot in some embodiments. In this way, the autonomous working robot directly obtains the map data from the local memory in some embodiments. The map data is obtained before or after the autonomous working robot moves from the vehicle transporting the autonomous working robot to the ground of the non-working area in some embodiments. Certainly, in the embodiments of this application, the autonomous working robot further obtains the map data from another device different from the autonomous working robot in some embodiments. For example, the autonomous working robot obtains the map data from the cloud in some embodiments, for example, obtains the map data from the cloud according to position information of the autonomous working robot or scheduling information thereof on a current day in some embodiments, to avoid occupying a large storage space of the autonomous working robot because map data is locally prestored. Specifically, the map data of the working area is obtained from the cloud based on the scheduling information on the current day before or after the autonomous working robot moves from the vehicle transporting the autonomous working robot to the ground of the non-working area in some embodiments. In some other implementations, the autonomous working robot does not obtain the scheduling information on the current day. After the vehicle transporting the autonomous working robot moves to the ground of the non-working area, the autonomous working robot obtains a map of a certain surrounding range thereof from the cloud based on the position information thereof, and pushes the map to a user for selection by the user. Based on the selection of the user, the autonomous working robot automatically enters the working area to perform work.

In some implementations, the prestored map data includes map data of one or more working areas in some embodiments. The one or more working areas include a working area (referred to as a first working area below) that the apparatus currently needs to enter to work. In this case, the map data of the working area is obtained from the map data of the one or more working areas in some embodiments.

In some implementations, the one or more working areas meets/meet a preset condition. In other words, the map data of the first working area is obtained from a set of map data of working areas that meet the preset condition.

In the embodiments of the present disclosure, the preset condition corresponding to the one or more working areas is not specifically limited. For example, the working area that meets the preset condition is a working area with a distance from the autonomous working robot being less than or equal to a first distance threshold in some embodiments.

The working area with the distance from the autonomous working robot being less than or equal to the first distance threshold is any one or more working areas in a circle determined with the position of the autonomous working robot as the center and the first distance threshold as the radius in some embodiments, or is a working area with a distance (for example, a linear distance) between the autonomous working robot and a boundary or a center of the working area being less than or equal to the first distance threshold in some embodiments.

The value of the first distance threshold is not limited in the embodiments of the present disclosure. For example, the first distance threshold is 1 kilometer, 2 kilometers, or the like in some embodiments. For example, the value of the first distance threshold may not be set excessively large, to avoid the case that when an excessively large number of working areas meet the preset condition, it takes a long time and is difficult to obtain the map data of the first working area.

However, the embodiments of the present disclosure are not limited thereto. For example, the preset condition corresponding to the one or more working areas further includes another preset condition in some embodiments, for example, to-be-performed tasks corresponding to the one or more working areas are of the same type.

A manner of obtaining the map data of the first working area is not specifically limited in the embodiments of the present disclosure. For example, when the preset map data includes map data of one or more working areas, the map data of the first working area is obtained in one or more of the following manners in some embodiments.
Manner 1: Retrieve (invoke) the map data of the first working area from a set of prestored map data of different working areas according to positioning data of the autonomous working robot.

As an example, the autonomous working robot retrieves map data of a working area closest to the autonomous working robot from the set of map data according to the positioning data as the map data of the first working area in some embodiments. A manner of automatic retrieval by the autonomous working robot is used to obtain the map data of the first working area, so that the level of automation of the autonomous working robot can be improved, and manual participation is reduced.
Manner 2: Retrieve the map data of the first working area from a set of prestored map data of different working areas according to preset scheduling data of the autonomous working robot.

As an example, in a case that the autonomous working robot needs to perform working tasks in different working areas within a time range, these working tasks to be performed are scheduled in advance in some embodiments, to sequentially determine the map data of the first working area according to the scheduling data.

For example, to-be-performed working tasks of the autonomous working robot within one day include a working task of the first working area, a working task of a second working area, and a working task of a third working area, and a schedule of these to-be-performed working tasks is an execution order in which the working task of the first working area comes before the working task of the second working area and the working task of the second working area comes before the working task of the third working area. In this case, when starting to perform the first working task on this day, the autonomous working robot directly retrieves the map data of the first working area. After the working task of the first working area is finished, map data of the second working area is automatically retrieved in some embodiments.
Manner 3: Receive the map data of the first working area sent by a server based on scheduling of the autonomous working robot.

In Manner 3, the map data of the first working area does not need to be retrieved by the autonomous working robot, and instead is directly sent by the server to the autonomous working robot. As an example, the server stores scheduling data of to-be-performed tasks corresponding to the autonomous working robot. The server directly sequentially sends map data of working areas corresponding to the working tasks to be performed to the autonomous working robot according to the stored scheduling data in some embodiments.

The preset map data is used to control the autonomous working robot to move from the outside of the first working area into the first working area, so that the safety of a control process of the autonomous working robot and the passability of a movement path of the autonomous working robot can be effectively improved.
Manner 4: Manually retrieve the map data of the first working area.

As an example, the map data of the first working area is directly selected and retrieved from the set of prestored map data of different working areas in a manual manner in some embodiments. The map data of the first working area is obtained in a manner of manual selection and retrieval, so that it can be ensured that the retrieved map data of the first working area is more accurate.

In the embodiments of this application, the controller in the autonomous working robot performs a control process, outputs a corresponding driving instruction based on the sensing data to control the first movement trajectory of the autonomous working robot moving from the vehicle transporting the autonomous working robot to the ground of the non-working area, and outputs a corresponding driving instruction according to the map data and sensing data, to control the second movement trajectory of the autonomous working robot moving from the ground of the non-working area to the working area in some embodiments, so that the autonomous working robot can autonomously move from a transport vehicle to the working area along the first movement trajectory and the second movement trajectory, thereby avoiding a case that when the transport vehicle cannot park near the working area, a worker needs to carry the autonomous working robot from a get-off point of the transport vehicle to the working area, and helping to improve the level of automation of the autonomous working robot.

In another aspect, the controller in the autonomous working robot controls, based on the sensing data, the first movement trajectory of the autonomous working robot moving from the transport vehicle to the non-working area, and controls, based on the map data and the sensing data, the second movement trajectory of the autonomous working robot moving from the non-working area to the working area in some embodiments, thereby helping to improve the accuracy of controlling the first movement trajectory and the second movement trajectory by the controller, or in other words, helping to improve the accuracy of controlling an entry movement trajectory of the autonomous working robot by the controller.

As discussed above, the sensor assembly includes a positioning sensor in some embodiments. Implementations of positioning of the autonomous working robot based on the positioning sensor are different in different scenarios in some embodiments. In some scenarios, when a carriage of the transport vehicle is totally enclosed, the reception of a carrier phase differential technique (real-time kinematic, RTK) signal is affected in some embodiments. In this case, in the transport vehicle, the positioning sensor in the autonomous working robot forms relative coordinates through a non-RTK signal for positioning in some embodiments. Later, after the autonomous working robot moves out of the transport vehicle to enter a wide area, the reception of an RTK signal becomes normal again. In this case, the autonomous working robot is positioned by forming precise absolute coordinates through an RTK signal in some embodiments.

In some other scenarios, when the carriage of the transport vehicle is semi-enclosed, the impact on the reception of an RTK signal is small in some embodiments. In this case, in the transport vehicle, the positioning sensor in the autonomous working robot forms precise absolute coordinates through an RTK signal for positioning in some embodiments.

To further improve the level of automation of the autonomous working robot, the autonomous working robot in the embodiments of this application further autonomously moves from a working area to a non-working area, and autonomously moves from the non-working area to the transport vehicle in some embodiments. In other words, the autonomous working robot autonomously completes an exit process in some embodiments.

The controller is further configured to determine whether a return condition is met; and perform a return control process in response to the return condition being met.

The return condition is used for determining whether the autonomous working robot can leave the working area and return to the transport vehicle. In an implementation, whether the controller receives an external instruction is used for determining whether the return condition is met in some embodiments. When the controller 240 receives the external instruction, it is determined that the return condition is met, to perform the return control process. When the controller 240 does not receive the external instruction, it is determined that the return condition is not met, and the autonomous working robot remains in a current state.

For example, the return condition being met is that the controller 240 receives an input of a return instruction in some embodiments. To be specific, when an external trigger signal is transferred to the controller 240 and the controller 240 receives the trigger signal, it is considered that the autonomous working robot meets the exit condition, to perform the exit control process (return control process).

In another implementation, the controller is configured to receive the sensing data, and determine, based on the sensing data, whether the return condition is met. When the return condition is met, the controller autonomously generates a return control signal, and performs the return control process in response to the return control signal. In other words, the controller is configured to receive the sensing data and autonomously generate the return control signal, and perform the return control process in response to the return control signal. Specifically, in some embodiments, a condition for the controller to autonomously generate the return control signal being met includes: the controller detects, based on the sensing data, that the autonomous working robot completes the working task of the working area and parks at a preset parking position.

As discussed above, the vehicle transports the autonomous working robot near the working area. The positioning sensor is disposed on the autonomous working robot to detect position data of the autonomous working robot, and the position data is transferred to the controller 240. When the controller recognizes, based on the position data, that the autonomous working robot completes a working task in a current working area and moves to a preset parking area, it is determined that the autonomous working robot meets the return condition, to perform the return control process. It needs to be noted that, the preset parking position is set as a standby position discussed below in some embodiments. The standby position is described below in detail with reference to specific embodiments. Refer to the following description for the related description of the standby position. Details are not described herein.

In this embodiment, an example in which the return condition is receiving the return instruction is used to describe the return control process. The controller is further configured to receive an input of a return instruction; and perform a return control process in response to the return instruction in some embodiments. In other embodiments, the return control process performed by the controller after another return condition is met is approximately the same. Details are not described here again.

The return control process includes: outputting a corresponding driving instruction according to the map data and sensing data, to control a third movement trajectory of the autonomous working robot moving from a working area to a ground of a non-working area; obtaining vehicle position data used for indicating position information of the vehicle; and outputting a corresponding driving instruction according to the vehicle position data and the sensing data, to control a fourth movement trajectory of the autonomous working robot moving from the ground of the non-working area to the vehicle.

Continuing to refer to FIG. 3, in some embodiments, the controller outputs a corresponding driving instruction according to the map data and the sensing data, to control a third movement trajectory 350 of the autonomous working robot moving from the working area 330 to the ground of the non-working area 310; obtains the vehicle position data used for indicating position information of the vehicle; and outputs a corresponding driving instruction according to the vehicle position data and the sensing data, to control a fourth movement trajectory 360 of the autonomous working robot moving from the ground of the non-working area 310 to the transport vehicle 100.

The return instruction is used for indicating to the autonomous working robot to move back to the transport vehicle. In some implementations, the return instruction is triggered by a worker in some embodiments. For example, the return instruction is triggered by the worker to the autonomous working robot through a terminal device (for example, a mobile phone) in some embodiments. In another example, an input apparatus (for example, a button) for inputting the return instruction is disposed on the autonomous working robot in some embodiments. Correspondingly, the worker inputs the return instruction to the autonomous working robot through the input apparatus in some embodiments.

Various types of vehicle position data used for indicating the position information of the vehicle is included in some embodiments. This is not limited in the embodiments of this application. For example, the vehicle position data includes data of a position of a get-off point of the autonomous working robot in some embodiments. In another example, the vehicle position data includes data of a position on a ramp in some embodiments. In another example, the vehicle position data further includes data of a course confirmation position of the autonomous working robot in some embodiments. In another example, the vehicle position data is further included in position data after the positioning data of the autonomous working robot meets a precision condition (for example, has converged) in some embodiments. In some implementations, the vehicle position data is represented as absolute coordinates in some embodiments.

For ease of understanding, vehicle data in the embodiments of this application is described below with reference to FIG. 4. It needs to be noted that, the same numerals are used for elements with the same meaning in FIG. 3 and FIG. 4.

In some implementations, the vehicle position data includes a position of a get-off point of the autonomous working robot 110 in some embodiments. Referring to FIG. 4, if the autonomous working robot 110 moves from the transport vehicle 100 to the ground of the non-working area 310 through the ramp 120, in this case, a position of a get-off point 410 is a position at which a driving apparatus (for example, four wheels) of the autonomous working robot is completely landed in some embodiments.

In some implementations, the vehicle position data includes a course confirmation position of the autonomous working robot 110 in some embodiments. Referring to FIG. 4, after moving from the transport vehicle 100 to the ground of the non-working area 310 through the ramp 120, the autonomous working robot 110 continues to move for a distance (for example, 1 m to 2 m) to confirm a heading angle of the autonomous working robot in some embodiments. Therefore, a course confirmation position 420 is at a distance from the get-off point 410 in some embodiments. In some implementations, a movement path in confirming the heading angle is a linear path in some embodiments.

The vehicle position data is obtained in a plurality of manners. In some implementations, the positioning sensor on the transport vehicle 100 sends the vehicle position data of the transport vehicle 100 to the autonomous working robot 110. The positioning sensor on the transport vehicle 100 directly sends a vehicle position to the autonomous working robot 110 in some embodiments, or the positioning sensor on the transport vehicle 100 sends a vehicle position to the autonomous working robot 110 through a terminal of a worker or a cloud server in some embodiments.

In some other implementations, the autonomous working robot 110 obtains the position thereof through the positioning sensor thereof, and determines, based on the position thereof, information related to the vehicle position of the transport vehicle 100 in some embodiments. For example, after completing the convergence of an RTK signal, the autonomous working robot 110 determines, according to the positioning of the autonomous working robot 110, coordinate data related to the position of the transport vehicle 100 in some embodiments. Refer to the foregoing description for the coordinate data related to the position of the transport vehicle 100. Details are not described again herein. In another aspect, in the manner in the embodiments of this application, the autonomous working robot 110 autonomously positions the ramp 120, to facilitate subsequent return to the transport vehicle 100 through the ramp 120 in some embodiments.

In the embodiments of this application, the controller of the autonomous working robot performs a return control process, and outputs a driving instruction according to the map data and sensing data, to control the third movement trajectory of the autonomous working robot moving from the working area to the ground of the non-working area in some embodiments. In addition, the driving instruction is outputted according to the vehicle position data and the sensing data, to control the fourth movement trajectory of the autonomous working robot moving from the ground of the non-working area to the vehicle, thereby helping to improve the accuracy of controlling the third movement trajectory and the fourth movement trajectory by the controller.

As discussed above, an entry movement path in an entry process of the autonomous working robot includes the first movement trajectory and the second movement trajectory. An exit movement path in the exit process of the autonomous working robot includes the third movement trajectory and the fourth movement trajectory. To reduce the complexity of controlling the entry and exit of the autonomous working robot, the exit movement path of the autonomous working robot is controlled based on one or more positions on the entry movement path in some embodiments.

In some implementations, the sensing data includes positioning data used for indicating position information of the autonomous working robot. The controller is further configured to: provide the sensing data to a first determination process, where the first determination process is used for determining whether a preset event occurs in the autonomous working robot; if a determination result is yes, record position data of at least one position of the autonomous working robot in the first movement trajectory and/or the second movement trajectory according to the positioning data in the sensing data in response to the occurrence of the preset event; and obtain the position data, and control the autonomous working robot to pass through the at least one position to return to the vehicle. The position data includes position data of the vehicle in some embodiments. In this case, the controller controls, based on the position data of the vehicle, the autonomous working robot to pass through the vehicle position indicated by the position data of the vehicle to return to the vehicle in some embodiments. The preset event includes one or more events that can be used for marking where a vehicle position is located, and is referred to as a first class preset event in some embodiments. For example, the first class preset event includes detecting that the autonomous working robot moves to a get-off point in some embodiments. In another example, the first class preset event includes detecting that the autonomous working robot moves to a course confirmation position in some embodiments. In another example, the first class preset event includes detecting that the positioning data of the autonomous working robot meets a preset precision condition in some embodiments.

As an example, the first determination process is implemented based on environmental data in the sensing data and a second determination process in some embodiments. The second determination process is used for determining, based on the environmental data, whether the autonomous working robot moves from the vehicle to the ground of the non-working area. In other words, when a determination result of the second determination process is yes, it indicates that a result of the first determination process is yes. In this case, the controller records, according to the positioning data in the sensing data, position data of at least one position after the autonomous working robot reaches the ground of the non-working area in some embodiments. The at least one position includes, for example, the get-off point 410, the course confirmation position 420, and/or the like in some embodiments.

As another example, the autonomous working robot moves from the transport vehicle to the ground of the non-working area through the ramp in some embodiments. Therefore, the second determination process is performed based on the sensing data of a tilt sensor and a slope sensor in the sensor assembly in some embodiments. The tilt sensor (which is, for example, an inertial measurement unit in some embodiments) is used for detecting a body tilt. The slope sensor is used for detecting a slope of a surface in a movement direction of the autonomous working robot, and the sensing data includes tilt data and slope data in some embodiments. Correspondingly, the controller is configured to determine, according to the tilt data and the slope data in the sensing data, whether the autonomous working robot moves from the vehicle to the ground of the non-working area through a ramp in some embodiments. If the controller determines, based on the tilt data and the slope data, that the autonomous working robot moves from the vehicle to the ground of the non-working area through the ramp, the determination result of the second determination process is yes. Correspondingly, the determination result of the first determination process is also yes. The controller records position data of at least one position after the autonomous working robot reaches the ground of the non-working area in some embodiments.

The determining, based on the tilt data and the slope data, whether the autonomous working robot moves from the vehicle to the ground of the non-working area through a ramp includes that if the body tilt detected by the tilt sensor is less than a body tilt threshold and the slope detected by the slope sensor is less than a slope threshold, the autonomous working robot moves from the vehicle to the ground of the non-working area through the ramp in some embodiments. In contrast, if the body tilt detected by the tilt sensor is greater than or equal to the body tilt threshold and/or the slope detected by the slope sensor is greater than or equal to the slope threshold, the autonomous working robot does not move from the vehicle to the ground of the non-working area through the ramp.

As discussed above, when performing the first determination process, if determining that the determination result of the first determination process is yes, the controller records, based on the positioning data, position data of at least one position of the autonomous working robot in the first movement trajectory and/or the second movement trajectory. Therefore, the precision of the positioning data directly affects the accuracy of the position data. When the accuracy of the position data is higher, the success rate of positioning the transport vehicle by the autonomous working robot is higher, making it easy for the autonomous working robot to return to the transport vehicle. Therefore, the controller performs a third determination process to determine whether the positioning data meets the preset precision condition in some embodiments.

In some implementations, the controller is further configured to: provide the positioning data in the sensing data to a third determination process; and if a determination result is yes, record, according to the positioning data in the sensing data, position data of at least one position of the autonomous working robot in the first movement trajectory and/or the second movement trajectory in response to the positioning data meets the preset precision condition in some embodiments.

Usually, in response to the positioning data meets the preset precision condition, it indicates that the positioning precision of the autonomous working robot is high. Correspondingly, the recorded position data of the at least one position of the autonomous working robot in the first movement trajectory and/or the second movement trajectory is relatively accurate. In this case, when a return path of the autonomous working robot is planned based on the position data, the return path of the autonomous working robot is appropriately planned. Specifically, the positioning data includes satellite positioning data; and the third determination process is used for determining whether the satellite positioning data meets the preset precision condition.

Continuing to refer to FIG. 4, the position data of the autonomous working robot in the first movement trajectory 320 includes position data of the get-off point 410 in some embodiments. In another example, referring to FIG. 4, the position data of the autonomous working robot in the second movement trajectory 340 includes position data of the course confirmation position 420 in some embodiments.

In some implementations, the position data of the autonomous working robot in the first movement trajectory 320 includes position data of the get-off point 410 in some embodiments. For example, when the autonomous working robot enters, the get-off point 410 is used as an end point of the first movement trajectory 320 in some embodiments. Correspondingly, when the autonomous working robot returns, the get-off point 410 is used as a starting point of the fourth movement trajectory 360 in some embodiments.

In some implementations, the position data of the autonomous working robot in the second movement trajectory 340 includes position data of the course confirmation position 420 in some embodiments. For example, when the autonomous working robot enters, the course confirmation position 420 is used as a starting point of the second movement trajectory 340 in some embodiments. Correspondingly, when the autonomous working robot returns, the course confirmation position 420 is used as an end point of the third movement trajectory 350 in some embodiments.

In some implementations, the controller is further configured to: if a determination result of the third determination process is yes, record, according to the positioning data in the sensing data, first trajectory data of the first movement trajectory and second trajectory data of the second movement trajectory in response to the positioning data meets the preset precision condition; control the third movement trajectory of the autonomous working robot according to the second trajectory data and the sensing data; and control the fourth movement trajectory of the autonomous working robot according to the first trajectory data and the sensing data.

The first movement trajectory partially or completely overlaps the fourth movement trajectory in some embodiments, and the second movement trajectory partially or completely overlaps the third movement trajectory in some embodiments. In the embodiments of this application, when the precision of the positioning data is high, data of the first movement trajectory and data of the second movement trajectory are recorded based on the positioning data in a movement process of the autonomous working robot in some embodiments. Correspondingly, the fourth movement trajectory of the autonomous working robot is controlled based on the data of the first movement trajectory and the sensing data, and the third movement trajectory of the autonomous working robot is controlled based on the data of the second movement trajectory and the sensing data, thereby helping to improve the accuracy of the third movement trajectory and the fourth movement trajectory.

As can be learned based on the foregoing description, in both the entry process and the exit process, the autonomous working robot needs to move between the vehicle and the non-working area through the ramp in some embodiments. In the embodiments of this application, when the autonomous working robot moves along the ramp, the objective of controlling the movement path of the autonomous working robot is to keep the autonomous working robot from sliding off the ramp. Therefore, the movement path of the autonomous working robot is controlled based on a distance between the autonomous working robot and an edge of the ramp in some embodiments.

In some implementations, the sensing data further includes environmental data reflecting an environment in which the autonomous working robot is located. The controller is further configured to: provide the environmental data in the sensing data to a processing process, where the processing process is used for extracting environmental data related to a ramp from the environmental data; determine a distance between the autonomous working robot and the edge of the ramp according to the extracted environmental data; and output a corresponding driving instruction according to the distance to control a movement trajectory of the autonomous working robot passing through the ramp.

In some implementations, the outputting a corresponding driving instruction according to the distance includes that when the distance is less than a distance threshold, it indicates that the autonomous working robot has a risk of moving outside the ramp in some embodiments. In this case, the driving instruction includes adjusting the movement direction of the autonomous working robot to keep the autonomous working robot from moving outside the ramp in some embodiments. In contrast, when the distance is greater than or equal to the distance threshold, it indicates that the autonomous working robot does not have a risk of moving outside the ramp. In this case, the driving assembly controls, according to the driving instruction, the autonomous working robot to continue to move in a current direction in some embodiments.

In the embodiments of this application, if the autonomous working robot moves along the ramp, the controller performs the processing process to extract the environmental data related to the ramp, determines the distance between the autonomous working robot and the edge of the ramp based on the environmental data related to the ramp, and outputs a corresponding driving instruction based on the distance, to control the movement trajectory of the autonomous working robot passing through the ramp in some embodiments, thereby helping to keep the autonomous working robot from moving out of the ramp to avoid damage to the autonomous working robot, so that the safety of the autonomous working robot moving along the ramp is improved.

As can be learned based on the foregoing description, after the autonomous working robot moves to the get-off point, the controller obtains map data of a working area of a working task to be performed; and outputs a corresponding driving instruction according to the map data and sensing data, to continue to control a second movement trajectory 340 of the autonomous working robot 110 moving from the ground of the non-working area 310 to the working area 330 in some embodiments. It needs to be noted that, the second movement trajectory 340 is at least partially a path autonomously planned by the autonomous working robot. In other words, the second movement trajectory is completely a path autonomously planned by the autonomous working robot in some embodiments. As known from the map data of the working area, the autonomous working robot sets a target position in the working area, and autonomously moves to the target position through the sensor assembly 230 thereof in some embodiments.

Certainly, the second movement trajectory is a combination of a path autonomously planned by the autonomous working robot and a preplanned path in some embodiments.

Specifically, in a control process of the autonomous working robot 110 moving from the ground of the non-working area 310 to the working area 330, the controller 240 further at least performs a navigation process, to control, based on the navigation process, the autonomous working robot 110 to move from the get-off point to the boundary of the working area or into the working area in some embodiments. The navigation process performed by the controller 240 is described below.

The controller is configured to obtain preset map data of a working area (first working area) of a to-be-performed working task.

The map data of the working area includes boundary data of the working area and guidance data used for guiding the autonomous working robot to move to the working area in some embodiments.

The boundary data of the working area is used for limiting a working area of the autonomous working robot in some embodiments, to ensure that when working in the working area, the autonomous working robot can automatically recognize the boundary data of the working area to avoid moving beyond a boundary corresponding to the working area. In some embodiments, the boundary data of the working area is further used for determining the guidance data in some embodiments. For example, matching is performed according to the boundary data of the working area to obtain corresponding guidance data.

In some embodiments, the boundary data of the working area is related data of a boundary delimited for the working area in a manual manner in some embodiments.

The guidance data is used for guiding the autonomous working robot to move from the get-off point to the working area in some embodiments. Specific content of the guidance data is not limited in the embodiments of the present disclosure. In some embodiments, the guidance data includes data used for indicating a first path (which is understood as an entry path of the working area in some embodiments) of the working area in some embodiments. The guidance data is described below in detail with reference to specific embodiments. Refer to the following description for the related description of the guidance data. Details are not described herein.

As discussed above, the controller is configured to control, according to the sensing data and the map data, the second movement trajectory of the autonomous working robot moving to the working area.

For example, the controller controls, based on the positioning data of the autonomous working robot, the autonomous working robot to move to the working area along a path indicated by the guidance data in the map data in some embodiments.

In the embodiments of the present disclosure, the autonomous working robot is controlled according to the map data of the working area of the working task to be performed to automatically move from the get-off point to the first working area in some embodiments, so that the problem that the autonomous working robot needs to be manually operated to move from outside the working area to the working area can be resolved.

In addition, the map data in the embodiments of the present disclosure includes preset guidance data used for guiding the autonomous working robot to move to the working area, so that the guidance data can be used to quickly control the autonomous working robot to move to the working area. In an aspect, the presence of the guidance data helps to guide the autonomous working robot to effectively avoid a surrounding obstacle, and therefore is applicable to a scenario with a number of surrounding obstacles or a complex landform. In another aspect, the autonomous working robot uses the preset guidance data to enter the working area in some embodiments, so that it is not necessary to set more path planning algorithms for the autonomous working robot, a data processing requirement of the autonomous working robot is low, and costs can be reduced to a certain degree.

As discussed above, the map data of the working area includes the boundary data and the guidance data of the working area in some embodiments.

In the embodiments of the present disclosure, the map data of the working area being preset is understood as that the map data of the working area is generated in advance or stored in advance in some embodiments.

In some embodiments, the map data of the working area is generated in advance based on coordinate information acquired by an apparatus with a positioning assembly. Based on this, the apparatus with the positioning assembly is used to acquire the coordinate information to acquire the map data in some embodiments. In consideration of that the autonomous working robot has the positioning assembly, the apparatus with the positioning assembly is an autonomous working robot in some embodiments. The apparatus with the positioning assembly is a small apparatus with the positioning assembly, for example, a cart with the positioning assembly in some embodiments. In some embodiments, when the autonomous working robot is a large apparatus or is difficult to operate, the positioning assembly on the autonomous working robot is disassembled and installed on the cart to provide the cart with a positioning function in some embodiments, thereby facilitating manual control.

A process of generating the map data of the working area based on the coordinate information acquired by the apparatus with the positioning assembly is not limited in the embodiments of the present disclosure. For example, the apparatus with the positioning assembly is manually operated in some embodiments to travel along a specified path and record coordinate information (or coordinate data), and the map data of the working area is generated based on the recorded coordinate information. In some embodiments, the action that the map data of the working area is generated based on the recorded coordinate information includes that: the apparatus with the positioning assembly uploads the acquired coordinate information to a server (for example, a cloud server), and the server generates the map data according to the coordinate information. In some embodiments, the action that the map data of the working area is generated based on the recorded coordinate information includes that the apparatus with the positioning assembly directly autonomously generates the map data according to the acquired coordinate information.

For example, the apparatus with the positioning assembly is an autonomous working robot 200. In some embodiments, a process of acquiring the coordinate information by the autonomous working robot 200 is that the autonomous working robot 200 is manually operated to autonomously travel along a specified path and record coordinates. For example, in some embodiments, the autonomous working robot 200 is manually operated through driving in person or in a remote manner. For example, the map data includes the boundary data of the working area, and the autonomous working robot 200 is manually operated to travel along a boundary of the working area by one lap and record coordinates, and the boundary data of the working area is generated based on recorded coordinate information.

For example, the apparatus with the positioning assembly is a cart with the positioning assembly. In some embodiments, a process of acquiring coordinate information by the cart is that the cart is manually pushed to travel along a specified path and record coordinates. For example, the map data includes first path data used for indicating a path to the working area. In some embodiments, the cart is manually pushed to completely travel along the first path once and record coordinates, and data of an entry path to the working area is generated based on recorded coordinate information.

As discussed above, in some embodiments, the map data of the working area includes the boundary data and the guidance data of the working area. Based on this, the coordinate information acquired by the apparatus with the positioning assembly includes one or more of the following information in some embodiments.
Information 1: Coordinate information of the boundary of the working area. The coordinate information of the boundary of the working area is used for determining the boundary of the working area, i.e., a working range of the autonomous working robot in some embodiments.
Information 2: Coordinate information of the first path to the working area. The coordinate information of the first path to the working area is used for determining the first path in some embodiments, making it convenient for the controller to control the autonomous working robot to enter the working area or leave the working area along the first path. In some embodiments, the coordinate information of the first path includes coordinate information of each coordinate point on the first path, for example, coordinate information of a path starting point of the first path, coordinate information of a path end point of the first path, and coordinate information of a coordinate point in the middle of the first path in some embodiments. In some embodiments, the coordinate information of the first path includes only coordinate information of some coordinate points on the first path, for example, coordinate information of coordinate points at intervals of 0.1 meter on the first path in some embodiments.
Information 3: Coordinate information of a boundary of a transfer area in communication with the working area. The coordinate information of the boundary of the transfer area is used for determining the boundary of the transfer area in some embodiments, making it convenient for the controller to control the autonomous working robot to pass through the transfer area to enter the working area or leave the working area.

It can be understood that the information 1 is related to the boundary data of the working area, and the information 2 and the information 3 is related to the guidance data of the working area.

In some embodiments, the guidance data is obtained in various manners. As an implementation, in consideration of that the guidance data and the boundary data of the working area are both included in preset map data, after the map data is obtained according to the foregoing manner of obtaining the map data, the guidance data is obtained in some embodiments. As an implementation, after the boundary data of the working area is obtained, matching is performed according to the boundary data of the working area in some embodiments, to obtain guidance data matching the boundary data of the working area.

In a scenario of obtaining guidance data through matching according to the boundary data of the working area, various matching manners are used in some embodiments. For example, in some embodiments, a user selects guidance data from a map catalog stored in the autonomous working robot according to the boundary data of the working area; or the autonomous working robot automatically matches guidance data according to the boundary data of the working area or a mark near the working area.

In an embodiment, as discussed above, the guidance data includes first path data, and the first path data is used for indicating a pre-established first path to the working area in some embodiments. The path starting point of the first path is located outside the working area, and the path end point of the first path is located at the boundary of the working area or located inside the working area in some embodiments.

In a case that the guidance data includes the first path data, the controller controlling the autonomous working robot to move from outside the working area to the working area includes two control processes in some embodiments. For details, refer to a first control process (i.e., a process of controlling the autonomous working robot to move from the get-off point to the path starting point of the first path) and a second control process (i.e., a process of controlling the autonomous working robot to move to the working area along the first path) shown in FIG. 10.

In the first control process, the controller is configured to control, according to the sensing data and the first path data, a movement trajectory of the autonomous working robot moving from outside (i.e., the get-off point) the working area to a point on the first path in some embodiments. In an embodiment, the controller is configured to control, according to the sensing data and the first path data, a movement trajectory of the autonomous working robot moving from outside (i.e., the get-off point) the working area to the path starting point of the first path in some embodiments. In the second control process, the controller is configured to control, according to the sensing data and the first path data, a movement trajectory of the autonomous working robot to move to the working area along the first path in some embodiments.

In some embodiments, in the first control process, if detecting that a distance between the position of the autonomous working robot and the position of the path starting point of the first path is large, in consideration of safety, the controller manually operates the autonomous working robot to move to the path starting point of the first path in some embodiments.

Specifically, the controller at least performs a detection process and at least one determination process, to determine, according to a determination result, whether the controller automatically controls the autonomous working robot to move to the starting point of the first path or a user manually operates the autonomous working robot to move to the starting point of the first path in some embodiments.

Detection process: In a process of controlling the autonomous working robot to move toward the path starting point of the first path, the controller detects the distance between the autonomous working robot and the path starting point of the first path according to the positioning data of the autonomous working robot and the first path data in some embodiments.

Determination process: The controller is configured to provide the detected distance between the autonomous working robot and the path starting point of the first path to a determination process in some embodiments. The determination process is used for determining whether the distance between the autonomous working robot and the path starting point of the first path is greater than a second distance threshold.

In some embodiments, if a determination result is yes (i.e., the distance between the autonomous working robot and the path starting point of the first path is greater than the second distance threshold), the controller controls, based on an operation instruction inputted by a user, the autonomous working robot to move to the starting point of the first path in some embodiments. In other words, the user operates (for example, the user drives or remotely controls) the autonomous working robot to move to the path starting point of the first path.

In some embodiments, if the determination result is no (i.e., the distance between the autonomous working robot and the path starting point of the first path is less than or equal to the second distance threshold), the controller controls, according to the sensing data and the first path data, the autonomous working robot to autonomously move from the get-off point to the path starting point of the first path in some embodiments.

As discussed above, the sensing data generated by the sensor assembly further includes environmental data used for indicating an environment in which the autonomous working robot is located in some embodiments. In this case, the controller combines the environmental data to implement precise control of the movement of the autonomous working robot in some embodiments.

In some embodiments, the controller combines the environmental data to control the autonomous working robot to move around an obstacle/a ground pit in some embodiments. For example, the autonomous working robot is controlled to move around an obstacle/a ground pit in the first control process, or the autonomous working robot is controlled to move around an obstacle/a ground pit in the second control process.

The first control process is used as an example. The controller is configured to provide the environmental data in the sensing data to a determination process in some embodiments. The determination process is used for determining whether the autonomous working robot encounters an obstacle/a ground pit in a process of moving toward the path starting point of the first path.

In some embodiments, if the determination result is yes, the controller controls the autonomous working robot to move around the obstacle/ground pit in some embodiments.

In some embodiments, in a case that the autonomous working robot determines that an obstacle is present, the autonomous working robot further determines whether the obstacle is a moving obstacle or a still obstacle in some embodiments. If the obstacle is a moving obstacle, the autonomous working robot waits for the obstacle to leave to continue to move toward the path starting point of the first path along the original path in some embodiments. If the obstacle is a still obstacle, the controller outputs a braking instruction to the driving assembly to control the autonomous working robot to brake in some embodiments.

In some embodiments, if the determination result is no, the controller controls the autonomous working robot to move toward the path starting point of the first path according to the original path in some embodiments.

The second control process is used as an example. The controller is configured to provide the environmental data in the sensing data to a determination process in some embodiments. The determination process is used for determining whether the autonomous working robot encounters an obstacle/a ground pit in a process of moving toward the working area along the first path.

In some embodiments, if the determination result is yes, the controller outputs a braking instruction to the driving assembly to control the autonomous working robot to brake in some embodiments.

In some embodiments, if the determination result is yes, the controller further controls the autonomous working robot to move around the obstacle/ground pit, and then returns to the first path, to control the autonomous working robot to continue to move to the working area according to the first path in some embodiments.

In some embodiments, if the determination result is no, the controller controls the autonomous working robot to move toward the working area according to the first path in some embodiments.

In some embodiments, the pit in the embodiments of the present disclosure is a pit with a depth greater than a threshold (the pit is deep). The reason is that in a case that the depth of the pit is small (the pit is shallow), the autonomous working robot directly moves forward over the pit without steering in some embodiments.

Referring to FIG. 2 again, in some embodiments, the autonomous working robot 200 further includes a prompt assembly 270. The prompt assembly 270 is electrically connected to the controller 240 in some embodiments. The prompt assembly 270 is configured to send a prompt signal according to a prompt instruction.

In a case that the autonomous working robot 200 includes the prompt assembly 270, in some embodiments, the controller 240 is further configured to: in a case that a determination result is yes (i.e., an obstacle exists) after the controller performs a determination process, in some embodiments, the controller outputs a prompt instruction to the prompt assembly, so that the prompt assembly sends out a prompt signal according to the prompt instruction. For example, in a process of the autonomous working robot moving toward the working area along the first path or in a process of the autonomous working robot moving from the transfer area toward the working area along a second path, if a result of a determination process performed by the controller is that an obstacle exists, the controller outputs a prompt instruction to the prompt assembly in some embodiments, so that the prompt assembly sends out a prompt signal.

In this way, if receiving the prompt signal, an external user performs manual processing according to an actual case in some embodiments. For example, the user manually removes the obstacle, or the user operates the autonomous working robot to move to the starting point of the first path or operates the autonomous working robot to move to the working area.

In some embodiments, if the obstacle is a moving obstacle (for example, a small animal, or a passing pedestrian), after receiving the prompt signal, the moving obstacle autonomously leaves according to the prompt signal.

In some embodiments, in a process of the controller controlling the autonomous working robot to move around the obstacle/ground pit, the controller further at least performs a detection process and a determination process.

The detection process is used for detecting a deviation distance when the autonomous working robot moves around the obstacle/ground pit. The deviation distance means a vertical distance by which the autonomous working robot deviates from a connecting line between a movement starting point thereof and the path starting point of the first path. It can be understood that the deviation distance is a distance caused when the autonomous working robot moves around the obstacle/ground pit. It can further be understood that the movement starting point of the autonomous working robot is a movement starting point when the autonomous working robot moves from outside the working area toward the working area, or in other words, a movement starting point when the autonomous working robot moves from outside the working area toward the path starting point of the first path. For example, the autonomous working robot is a commercial lawn mower. After getting off a working truck of a commercial team lawn mowing company, the commercial lawn mower first moves to the path starting point of the first path from a get-off point, and then moves toward the working area through the first path. The movement starting point of the commercial lawn mower is the get-off point of the commercial lawn mower in some embodiments.

The determination process is used for determining, according to detected deviation distance data, whether the deviation distance exceeds a predetermined range.

In some embodiments, if a determination result is yes (i.e., the autonomous working robot deviates far), a prompt instruction is outputted to the prompt assembly; and a braking instruction is outputted to the driving assembly to control the autonomous working robot to brake.

The predetermined range corresponding to the deviation distance is not specifically limited in the embodiments of the present disclosure. For example, in some embodiments, the predetermined range is set to a half of a straight-line distance between the movement starting point of the autonomous working robot and the path starting point of the first path. For example, a distance of the connecting line between the movement starting point of the autonomous working robot and the path starting point of the first path is 15 meters, and the predetermined range is set to 7.5 m in some embodiments.

In another embodiment, the guidance data includes boundary data of the transfer area.

In a case that the autonomous working robot passes through the transfer area to move toward the working area, the guidance data includes the boundary data of the transfer area in some embodiments. As discussed above, the transfer area is in communication with the working area. In some embodiments, that the transfer area is in communication with the working area is that the boundary of the transfer area overlaps the boundary of the working area. In some embodiments, that the transfer area is in communication with the working area is that the transfer area and the working area partially overlap.

In a case that the autonomous working robot passes through the transfer area to move toward the working area, in some embodiments, the controlling, according to the sensing data and the map data, a movement trajectory of the autonomous working robot moving to the working area includes: controlling, according to the sensing data and the boundary data, a movement trajectory of the autonomous working robot passing through the transfer area to move to the working area.

In a case that the autonomous working robot passes through the transfer area to move toward the working area, in some embodiments, the autonomous working robot further obtains second path data, where the second path data is used for indicating a second path from the transfer area to the working area, to move from the transfer area to the working area based on the second path. A path starting point of the second path is located outside the working area (and is located at the boundary of the transfer area or inside the transfer area), and a path end point of the second path is located at the boundary of the working area or located inside the working area in some embodiments.

In some embodiments, the second path is the shortest path planned by the autonomous working robot based on the positioning data and the boundary data of the working area. In some embodiments, the second path is a preset path.

After obtaining the second path data, in some embodiments, the controller controls, according to the obtained second path data and sensing data, the autonomous working robot to move from outside the working area to the working area.

In some embodiments, if the movement starting point of the autonomous working robot is located outside the transfer area, that the controller controls the autonomous working robot to move from outside the working area to the working area includes two control processes. For details, refer to a third control process (i.e., a process of controlling the autonomous working robot to move from outside the working area to the transfer area) and a fourth control process (i.e., a process of controlling the autonomous working robot to move from the transfer area to the working area) shown in FIG. 13.

In the third control process, in some embodiments, the controller is configured to control, according to the sensing data and the boundary data of the transfer area, a movement trajectory of the autonomous working robot moving from outside the transfer area to the transfer area. In the fourth control process, in some embodiments, the controller is configured to control, according to the sensing data and the second path data, a movement trajectory of the autonomous working robot moving from the transfer area to the working area.

In some embodiments, if the movement starting point of the autonomous working robot is located inside the transfer area, that the controller controls the autonomous working robot to move from outside the working area to the working area includes one control process. For details, refer to a fourth control process shown in FIG. 14. For detailed description of the fourth control process, refer to the related description about the fourth control process in the foregoing scenario in which the movement starting point of the autonomous working robot is located outside the transfer area.

In some embodiments, in the third control process, if detecting that a distance between the position of the autonomous working robot and the position of the transfer area is large, in consideration of safety, the controller manually operates the autonomous working robot to move to the transfer area.

Specifically, in some embodiments, the controller at least performs a detection process and at least one determination process, to determine, according to a determination result, whether the controller automatically controls the autonomous working robot to move to the transfer area or a user manually operates the autonomous working robot to move to the transfer area.

Detection process: In a process of controlling the autonomous working robot to move toward the transfer area, in some embodiments, the controller detects a distance between the autonomous working robot and any position on the boundary of the transfer area according to the positioning data and the boundary data of the transfer area.

Determination process: In some embodiments, the controller is configured to provide the detected distance between the autonomous working robot and any position on the boundary of the transfer area to a determination process. The determination process is used for determining whether the distance between the autonomous working robot and any position on the boundary of the transfer area is greater than a third distance threshold.

In some embodiments, if a determination result is yes (i.e., the distance between the autonomous working robot and any position on the boundary of the transfer area is greater than the third distance threshold), the controller controls, based on an operation instruction inputted by the user, the autonomous working robot to move to the transfer area.

In some embodiments, if a determination result is no (i.e., the distance between the autonomous working robot and any position on the boundary of the transfer area is less than or equal to the third distance threshold), the controller controls, according to the sensing data and the boundary data of the transfer area, the autonomous working robot to move to the transfer area.

In some embodiments, in a process of the controller controlling the autonomous working robot to move to the working area, a working assembly of the autonomous working robot is kept in a disabled state, to ensure the safety of traveling. For example, the autonomous working robot is an autonomous lawn mower. In a process of controlling the autonomous lawn mower to move to the working area, a mowing assembly of the autonomous lawn mower stops working, and the mowing assembly is lifted. In some embodiments, in a process of the autonomous working robot moving toward the working area, a caution light thereof is turned on, or when a road condition near the working area is complex (for example, a number of people or obstacles exist), a manual stop (APP, key) function is further set on a terminal device of the user, thereby further ensuring the safety of traveling.

To ensure the safety of traveling of the autonomous working robot outside the working area, in some embodiments, a movement speed of the autonomous working robot outside the working area is less than a movement speed of the autonomous working robot inside the working area.

As an implementation, in some embodiments, the driving assembly is configured to drive the autonomous working robot with a first preset power to move outside the working area, and the autonomous working robot has a first movement speed; and the driving assembly is configured to drive the autonomous working robot with a second preset power to move and work in the working area, and the autonomous working robot has a second movement speed. The first movement speed is less than the second movement speed.

For example, assuming that the movement speed of the autonomous working robot inside the working area is 2 meter/second, the movement speed of the autonomous working robot outside the working area cannot exceed 2 meter/second, and for example, is set to 1 meter/second in some embodiments.

In some embodiments, after the autonomous working robot moves from outside the working area to the working area, the autonomous working robot is first kept in a standby state, and after the user confirms related information, the controller controls the autonomous working robot to switch from a non-working state to a working state to start working. In the embodiments of the present disclosure, the content of the related information that the user needs to confirm is not limited. For example, for an autonomous lawn mower, in some embodiments, the related information includes a cutting height, a current charge, and the like. In some embodiments, the cutting height is estimated based on a big data mode according to a mowing frequency of a client.

A process of the autonomous working robot moving from outside the working area to the working area is described above. The process is understood as an entry process in some embodiments. An exit process of the autonomous working robot from the working area is briefly described below.

After a working task of a working area is completed, in some embodiments, the autonomous working robot moves outside the working area from the working area, for example, returns to a movement starting point thereof during entry.

In some embodiments, whether the working task of the working area is completed is determined by detecting a coverage rate. For example, in a case that the coverage rate is greater than 85%, in some embodiments, it is considered that the working task is completed.

In some embodiments, after the working task of the working area is completed, the autonomous working robot automatically returns to the movement starting point thereof during entry according to an entry path. In some embodiments, after the working task of the working area is completed, the autonomous working robot is kept in a standby state, and after the user confirms that the working task of the working area is completed, the autonomous working robot then returns according to the entry path. In some embodiments, after waiting for the user to confirm that the working task of the working area is completed, the autonomous working robot further needs to wait for the user to confirm whether the outside of the working area is in a safe state. In a case that the working task of the working area is completed and the outside of the working area is in a safe state, the autonomous working robot returns according to the entry path.

In some other embodiments, when needing to return to the transport vehicle, the autonomous working robot returns to a preset position first, and waits at the preset position for the user to apply an operation, to return to the transport vehicle in a relatively safe traveling environment and/or traveling state (for example, a state of the user operating to travel), thereby ensuring the safety of pedestrians.

It can be understood that if the autonomous working robot directly and automatically returns to the transport vehicle without waiting for the user to apply an operation, because the traveling environment is not confirmed and it also cannot be ensured that the autonomous working robot returns in a relatively safe traveling state, there is still a safety risk. In addition, an extra processing time is required to wait for the user to perform an operation and not to return to the preset position (for example, the autonomous working robot travels to the position of the user or waits in situ for the user to come over to perform an operation), affecting the working efficiency of the commercial team.

In some embodiments of this application, the autonomous working robot acquires environmental information and/or positioning information through a sensor, and transmits same to a control circuit for analysis and processing to generate instructions that can control the actions of the working assembly and the driving assembly, to autonomously work in different working areas, thereby reducing labor costs.

In some embodiments of this application, position data of the preset position for the autonomous working robot to return first after completing a working task is acquired in advance. For example, in some embodiments, position data of one or more positions is acquired in advance as the position data of the preset position. Further, when position data of a plurality of positions is acquired as the position data of the preset position, in some embodiments, the user selects a preset position to return during subsequent use, or the autonomous working robot selects an appropriate preset position to return according to distances. In the foregoing manner, in some embodiments, when needing to be operated by the user, the autonomous working robot autonomously travels to the preset position. When the user receives an operation prompt, in some embodiments, the user goes to the preset position, to shorten the time for implementing interaction, thereby improving working efficiency.

In some embodiments, the preset position is set by acquiring position data of an appropriate position in advance according to a surrounding environment of a home working area. For example, for a home lawn, a position in a home driveway near the home lawn or a position near a boundary where the home driveway and the lawn are connected is selected in some embodiments. In this way, it can be ensured that the autonomous working robot has a relatively spacious traveling environment, thereby improving the safety of traveling of the autonomous working robot. In another aspect, a plurality of preset positions is provided in some embodiments. In other words, in some embodiments, position data of a plurality of appropriate positions (for example, which are positions in the foregoing relatively spacious traveling environment in some embodiments) is set in advance according to the surrounding environment of the home working area. In this way, it is not necessary to return to a fixed position every time, which helps to avoid lawn wear.

In some embodiments, the preset position is alternatively determined according to a position of the autonomous working robot when traveling into the working area. In this way, the autonomous working robot can return to the transport vehicle approximately along the original entry path, thereby improving the safety of traveling of the autonomous working robot. In another aspect, position data of an entry position is recorded during entry into the working area, and it is not necessary to additionally choose another position used for interaction, so that steps are simplified. In addition, it is also convenient for people of the commercial team to place carried objects such as battery packs near the entry position after entry, thereby reducing the load of carrying the objects all along. In addition, when the user operates the autonomous working robot to enter the working area, an entry position of the autonomous working robot traveling into the working area each time is random in some embodiments. In other words, the autonomous working robot does not need to return to a fixed entry position each time, which helps to avoid lawn wear.

In some embodiments of this application, the operation that the autonomous working robot waits at the preset position for the user to apply includes opening a seat board for riding, confirming a traveling environment and pressing a button to confirm the return, manually driving the machine to return, or the like. Based on the foregoing operation, it is beneficial to provide the autonomous working robot with a relatively safe traveling environment and/or traveling state, thereby ensuring the safety of traveling of the autonomous working robot, and ensuring the safety of pedestrians.

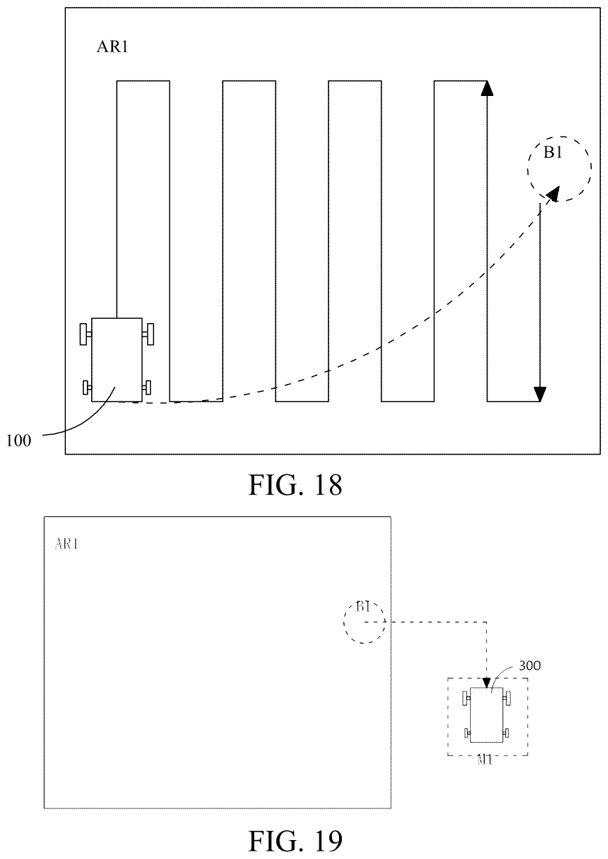

In this embodiment, referring to FIG. 17, FIG. 18, and FIG. 19, the autonomous working robot is configured to perform at least one working task in the working area. In some embodiments, the controller 240 is configured to obtain at least one working parameter of an autonomous working robot 300 when performing a current working task.

In some implementations of this embodiment, the obtained at least one working parameter includes at least one of execution progress, a driving power, a traveling speed, a working load, a battery level, and a map parameter of the current working task. For example, in some embodiments, the execution progress of the current working task is represented by a coverage rate of the working area by the autonomous working robot 300, or is represented by traveling progress of a planned working path. For example, in some embodiments, the map parameter is used for determining whether a new map is inputted/loaded, and for example, in some embodiments, is a quantity of downloaded maps, map receiving progress, or map download progress.

In some implementations of this embodiment, the autonomous working robot 300 obtains the foregoing working parameter in real time, for example, obtains the foregoing working parameter every 50 ms, 100 ms, 500 ms, 1 s, or 2 s, so that it can be monitored in real time whether the autonomous working robot 300 needs to return to a preset parking position.

In some implementations of this embodiment, some working parameters need to be obtained in real time, and some other working parameters do not need to be obtained in real time. For example, the execution progress, the working load, and the battery level of the current working task need to be obtained in real time, and in some embodiments, the map parameter is obtained after it is determined that the execution progress of the current working task meets a condition.

The controller 240 is further configured to: determine, according to the at least one working parameter, whether the autonomous working robot 300 needs to return to a preset parking position located outside the working area, and if a determination result is yes, control the autonomous working robot 300 to travel to a preset position to wait for a user operation to be applied, where the preset parking position is different from the preset position.

It can be understood that the preset parking position and the preset position are two different positions. For example, in some embodiments, the preset position is located inside the working area, or is located outside (for example, an internal driveway of a home) the working area, or is located on a boundary of the working area. For example, in some embodiments, the preset parking position is an internal driveway of a home, or is a public area outside a home. For example, in some embodiments, the preset parking position is a parking position in a carriage of a transport vehicle near the working area, or is a parking position set in a charging station outside the working area. In some embodiments, the transport vehicle transports the autonomous working robot 300 to different working areas (including working areas of different districts) to perform working tasks.

In some implementations of this embodiment, the preset position is acquired by the commercial team in advance and stored in a memory, so that the preset position can be invoked at any time when the autonomous working robot 300 needs to use the preset position. In addition, as discussed above, one or more preset positions are provided in some embodiments. For example, in some embodiments, the memory is a local memory, for example, is a memory in the autonomous working robot 300, or is mounted in a virtual server through a cloud storage technology (for example, in a cloud disk form).

In some embodiments, a condition for that the autonomous working robot 300 needs to return to the preset parking position is that the current working task is completed, and a correspondingly obtained working parameter is the execution progress of the current working task. For example, as shown in FIG. 18, in some embodiments, when the execution progress of the current working task (for example, the coverage rate of the working area or the traveling progress of the planned working path) is 100%, it is determined that the autonomous working robot 300 needs to return to a preset parking position B1. In some embodiments, position data of a preset position B1 is invoked to control the autonomous working robot 300 to first travel to the preset position B1 to wait for a user operation and then return to the preset parking position based on the applied user operation.

In some embodiments, a condition for that the autonomous working robot 300 needs to return to the preset parking position is alternatively that the current working task is completed and no other map data is being inputted/loaded, and a correspondingly obtained working parameter is the execution progress of the current working task and the map parameter as described above. For example, when the autonomous working robot 300 detects that the current working task is completed and no other map data is inputted/loaded, in some embodiments, it is determined that there is no more area in which the autonomous working robot 300 needs to work in a current district. In some embodiments, the position data of the preset position is invoked to control the autonomous working robot 300 to first travel to the preset position to wait for a user operation, then make the autonomous working robot 300 to return to the carriage of the transport vehicle, and then transport the autonomous working robot 300 to a next district through the transport vehicle to work.

In some embodiments, a condition for that the autonomous working robot 300 needs to return to the preset parking position is alternatively that the autonomous working robot 300 needs to return to a preset parking position outside the working area to charge the battery, and a correspondingly obtained working parameter is the battery level of the autonomous working robot 300. For example, when it is detected that the battery level is less than or equal to a predetermined value, in some embodiments, it is determined that the autonomous working robot 300 needs to return to the preset parking position for charging. In some embodiments, the position data of the preset position is invoked to control the autonomous working robot 300 to first travel to the preset position to wait for a user operation and then return to the preset parking position based on the applied user operation.

In some implementations of this embodiment, as shown in FIG. 17, the preset position is alternatively recorded when the autonomous working robot 300 enters the working area. To be specific, an entry position B1 when the autonomous working robot 300 enters a working area AR1 from a preset parking position M1 outside the working area is used as the preset position. Further, when the autonomous working robot 300 obtains positioning data with higher precision by calibrating a heading direction near an entry area, a position at which the autonomous working robot 300 completes the calibration of the heading direction is alternatively used as the preset position in some embodiments.

In some implementations of this embodiment, position data of one or more preset positions is acquired in advance, or an entry position of the autonomous working robot 300 is used as one of the preset positions. In this way, the autonomous working robot 300 can be kept from returning to a fixed preset position every time, thereby reducing lawn wear.

In some implementations of this embodiment, the at least one preset position is located inside and/or at the boundary of the working area. In this way, the autonomous working robot 300 can be kept from traveling outside the working area when performing the current working task, thereby further improving the safety of the autonomous working robot 300.

The controller 240 is further configured to: make, based on the applied user operation, the autonomous working robot 300 to return to the preset parking position, and switch to a state of waiting to perform a next working task or shut down.

In some implementations of this embodiment, as shown in FIG. 19, based on the applied user operation, the autonomous working robot 300 returns to the preset parking position M1. Specifically, three following manners are included in some embodiments:
(1) Return in an automatic mode: After the user manually confirms at the preset position that the autonomous working robot 300 can return, the autonomous working robot 300 autonomously returns to the preset parking position M1 from the preset position B1.

For example, at the preset position, after confirming that the traveling environment is safe, in some embodiments, the user inputs a return confirmation instruction to the autonomous working robot 300, and based on the instruction, the controller 240 controls the autonomous working robot 300 to automatically return to the preset parking position. An interaction assembly (for example, a button, a key, or a touch panel) is disposed on the autonomous working robot 300 in some embodiments to make it convenient for the user to input the return confirmation instruction, or certainly the user sends the return confirmation instruction to the autonomous working robot 300 through an APP at the preset position in some embodiments.
(2) Return in a manual mode: The autonomous working robot 300 returns to the preset parking position M1 from the preset position B1 under the operation by the user.

For example, in some embodiments, at the preset position, the user inputs an instruction of confirming switching to the manual mode to the autonomous working robot 300, so that in the manual mode, the autonomous working robot 300 returns to the preset parking position M1 based on the operation of the user in some embodiments. An operating rod is disposed on the autonomous working robot 300 in some embodiments, so that in some embodiments, in the manual mode, the user rides the autonomous working robot 300 to use the operating rod to operate the autonomous working robot 300 to return to the preset parking position M1. In some embodiments, in the manual mode, the user further uses a remote control to remotely control the autonomous working robot 300 to return to the preset parking position M1.
(3) Return by combining a manual mode and an automatic mode: The autonomous working robot 300 travels near the preset parking position M1 from the preset position B1 under the operation of the user, then the user switches the manual mode to the automatic mode, and finally the autonomous working robot 300 autonomously returns to the preset parking position M1.

For example, in some embodiments, at the preset position, the user inputs the instruction of confirming switching to the manual mode to the autonomous working robot 300, so that in some embodiments, in the manual mode, the autonomous working robot 300 travels near the preset parking position M1 based on the operation of the user. Next, in some embodiments, the user inputs an instruction of confirming switching to the automatic mode to the autonomous working robot 300, so that based on the instruction, the autonomous working robot 300 autonomously returns to the preset parking position M1. The interaction assembly and the operating rod (which is alternatively the remote control in some embodiments) described above is disposed on the autonomous working robot 300 in some embodiments.

In summary, in the foregoing manner, in some embodiments, the autonomous working robot 300 at least passes through one preset position before returning to the preset parking position, and waits for a user operation at the preset position, so that the autonomous working robot 300 returns to the preset parking position in a safer traveling environment and/or a safer traveling state, thereby ensuring the safety of pedestrians.

Some implementations that can be used by the autonomous working robot 300 in the foregoing embodiments are further provided below.

In some implementations, before the autonomous working robot 300 performs a working task, when implementing a control procedure in this embodiment, the controller 240 further implements the following steps: obtaining map data of a working area, where the map data of the working area includes position data of at least one preset position. In other words, in some embodiments, the position data of the preset position is included in a map data package of the working area, so that when obtaining a map of the working area, the autonomous working robot 300 simultaneously obtains the position data of the preset position in some embodiments, thereby improving working efficiency.

In some embodiments, the obtaining map data of a working area includes: acquiring position data of the boundary of the working area and the position data of at least one preset position; and generating the map data according to the acquired position data. In other words, in some embodiments, the position data of the preset position is acquired in advance in a process of acquiring the boundary of the working area, so that the preset position can also be included in the generated map of the working area and is downloaded together with the map, to facilitate subsequent obtaining of the position data of the preset position.

Further, the controller is configured to: obtain position data of an entry position through which the autonomous working robot enters the working area, where the position data of the preset position includes the position data of the entry position through which the autonomous working robot enters the working area. The position data of the entry position is recorded during entry into the working area, and it is not necessary to additionally choose another position used for interaction, so that steps are simplified. In addition, it is also convenient for people of the commercial team to place carried objects such as battery packs near the entry position after entry, thereby reducing the load of carrying the objects all along.

In some implementations, a starting position through which the autonomous working robot enters the working area from the non-working area, or an arrival position at which the autonomous working robot arrives at the working area from the non-working area is used as a standby position of the autonomous working robot in some embodiments. In this way, after moving to the standby position, the autonomous working robot waits whether to perform a working task in some embodiments.

In some implementations, the sensing data includes positioning data used for indicating position information of the autonomous working robot and environmental data reflecting an environment in which the autonomous working robot is located. The controller is further configured to: provide the environmental data in the sensing data to a fourth determination process, where the fourth determination process is used for determining whether the autonomous working robot moves from the ground of the non-working area to the working area; and if a determination result is yes, record, according to the positioning data in the sensing data, position data of a position of the autonomous working robot when the autonomous working robot reaches the working area, where the recorded position data is used for indicating the standby position of the autonomous working robot.

In the embodiments of this application, the autonomous working robot is located at the standby position to interact with a user in some embodiments. For example, in an entry process, the autonomous working robot first arrives at the standby position in some embodiments, and then confirms working parameters related to the working task with the user in some embodiments. In another example, in a process of getting ready to exit, the autonomous working robot first arrives at the standby position in some embodiments, and then confirms with the user whether exit is allowed in some embodiments. Solutions of interacting with the user at the standby position by the autonomous working robot are respectively described below from the perspectives of the entry process and the exit process. In another embodiment, in the entry process, after arriving at the standby position, the autonomous working robot automatically enters the working area in some embodiments. In the process of getting ready to exit, after arriving at the standby position, the autonomous working robot automatically leaves the working area to enter the non-working area in some embodiments.

In the embodiments of this application, referring to FIG. 2, an interaction assembly 250 is disposed on the autonomous working robot in some embodiments. The interaction assembly 250 is electrically connected to the controller, and is configured to perform information interaction with a user in some embodiments. The interaction assembly includes, for example, a display screen in some embodiments. In addition, a working assembly 260 is disposed on the autonomous working robot, is electrically connected to the controller, and is configured to perform one or more working tasks in some embodiments. For example, the autonomous working robot is a lawn mower. The working assembly includes, for example, a cutting mechanism in some embodiments.

If the autonomous working robot enters, the controller is further configured to: when it is detected that the autonomous working robot arrives at the working area, control the autonomous working robot to stay at the standby position; control the interaction assembly to display working parameter information corresponding to the working area; receive an input of confirmation information about the working parameter information by a user; and output a corresponding instruction, to control the autonomous working robot to turn on the working assembly 260 and start to perform at least one working task.

The working parameter information corresponding to the working area includes historical working parameter information of the working area in some embodiments. For example, the historical working parameter information is working parameters used when the autonomous working robot performs the working task in the working area previously in some embodiments. In another example, the historical working parameter information is the working parameters of the working area pushed according to a big data mode in some embodiments. For example, the autonomous working robot is an autonomous lawn mower. The foregoing working parameters include an area that the autonomous lawn mower needs to mow, a lawn retention height after grass cutting of the autonomous lawn mower, a cutting height, a movement speed, and the like in some embodiments.

In the embodiments of this application, after entering the working area, the autonomous working robot confirms working parameters with a user at the standby position in some embodiments. In another aspect, the controller in the autonomous working robot controls the interaction assembly to display the working parameter information corresponding to the working area for confirmation by the user in some embodiments, thereby helping to reduce the complexity of confirming working parameters by the user and improve user experience.

If the autonomous working robot gets ready to exit, in some embodiments, the controller is further configured to: after it is detected that a current working task is completed, control the autonomous working robot to stop the working assembly and return to the standby position; control the interaction assembly to display information used for indicating to select to return/continue to perform at least one working task; receive an input of confirmation information about the selection to return/continue to perform at least one working task; and output a corresponding instruction, to control the autonomous working robot to return/continue to perform at least one working task.

In some implementations, the interaction assembly simultaneously displays two types of options of whether to agree to return and whether to continue to perform the working task for selection by a user in some embodiments. Certainly, the interaction assembly displays only one type of option, for example, displays the options of whether to agree to return in some embodiments. For this type of option, the interaction assembly displays an option of agreeing to return and an option of not agreeing to return in some embodiments. In this way, when the user selects the option of agreeing to return, the autonomous working robot returns to the transport vehicle in the return manner described above in some embodiments. In contrast, if the user selects the option of not agreeing to return, the autonomous working robot continues to perform the working task in the working area in some embodiments.

Certainly, in the embodiments of this application, the interaction assembly displays an option of confirming whether to perform another type of task (for example, whether to perform a charging task) in some embodiments or the interaction assembly displays an option of confirming whether to go to another nearby working area to perform a task in some embodiments. This is not limited in the embodiments of this application.

For example, the type of option of whether to continue to perform the working task are displayed. In this type of option, the interaction assembly displays an option of continuing to perform the working task and an option of not continuing to perform the working task in some embodiments. In this way, when a user selects the option of not continuing to perform the working task, the autonomous working robot returns to the transport vehicle in the return manner described above in some embodiments. In contrast, if the user selects the option of continuing to perform the working task, the autonomous working robot continues to perform the working task in the working area in some embodiments.

In the embodiments of this application, the autonomous working robot autonomously moves from the vehicle to the non-working area and then moves from the non-working area to the working area in some embodiments. Therefore, how to improve the safety of the autonomous working robot in a movement process is another problem considered in the embodiments of this application. A solution of improving the safety of the autonomous working robot in the movement process in the embodiments of this application is described below.

As discussed above, in some scenarios, in a process of moving from the transport vehicle to the non-working area, the autonomous working robot passes through a ramp in some embodiments. To improve the safety of the autonomous working robot moving on the ramp, a movement speed of the autonomous working robot on the ramp is controlled in some embodiments. For example, the movement speed of the autonomous working robot on the ramp is controlled to be less than a movement speed of the autonomous working robot in the working area in some embodiments.

For example, the driving assembly is configured to drive the autonomous working robot with a first preset power to move on the ramp in some embodiments, where the autonomous working robot has a first movement speed; the driving assembly is configured to drive the autonomous working robot with a second preset power to move and work in the working area in some embodiments, where the autonomous working robot has a second movement speed, where the first movement speed is less than the second movement speed.

To improve the safety of the autonomous working robot in the movement process of the autonomous working robot, when the controller performs the entry control process and performs the return control process, the working assembly of the autonomous working robot is controlled to stop working in some embodiments. For example, the controller is further configured to: in a process of performing the entry control process and the return control process, control the autonomous working robot to stop the working assembly.

In an autonomous movement process, the autonomous working robot encounters a sudden event in some embodiments, and as a result the autonomous working robot cannot safely return to the transport vehicle, or the autonomous working robot cannot safely move to the working area. Therefore, to improve the safety of the autonomous working robot in the movement process of the autonomous working robot, in some embodiments, it is set that the autonomous working robot sends a prompt instruction to the outside (a user or a person near the autonomous working robot) when encountering a sudden event, and controls the autonomous working robot to brake.

In some implementations, the prompt instruction is sent by a prompt assembly 270 in the autonomous working robot to the outside in some embodiments. For example, the controller is further configured to: provide the environmental data in the sensing data to a fifth determination process, where the fifth determination process is used for determining whether the autonomous working robot encounters a sudden event; if a determination result is yes, output a prompt instruction to the prompt assembly; and output a braking instruction to the driving assembly to control the autonomous working robot to brake. The environmental data is used for reflecting an environment in which the autonomous working robot is located.

In some implementations, the prompt assembly 270 includes, for example, a voice broadcast assembly, and a light alarm assembly in some embodiments.

It needs to be noted that, the determination processes above include the first determination process to the fifth determination process. Some or all determination functions in the five determination processes are implemented by one determination process in some embodiments, or are independently implemented by a plurality of determination processes in some embodiments. This is not limited in the embodiments of this application.

In some implementations, the sudden event includes at least one of the following event: feature detection related to the vehicle is abnormal before the apparatus gets on the vehicle; distance detection for deviation from a predetermined movement route is abnormal in an obstacle avoidance process; and slope detection in an environment in which the autonomous working robot is located is abnormal in a movement process.

The feature detection related to the vehicle being abnormal includes that a ramp cannot be detected at a vehicle position indicated by the vehicle position data in some embodiments. For example, after the transport vehicle is moved, a sudden event of the feature detection related to the vehicle being abnormal often occurs.

In the embodiments of this application, when the feature detection related to the vehicle is abnormal, the autonomous working robot fails to safely return to the transport vehicle in some embodiments. Therefore, the event is used as the sudden event, which helps to increase the possibility that the autonomous working robot moves safely.

In some embodiments, the distance detection for deviation from the predetermined movement route being abnormal in the obstacle avoidance process includes that in the obstacle avoidance process, a distance by which the autonomous working robot deviates from the predetermined movement route is greater than or equal to a distance threshold. For example, in the movement process of the autonomous working robot, obstacles on the movement path change in some embodiments. When the autonomous working robot switches to a longer path to avoid an obstacle, in this case, the sudden case is triggered in some embodiments.

In the embodiments of this application, when the distance detection for deviation from the predetermined movement route is abnormal in the obstacle avoidance process, the autonomous working robot fails to return to the movement path in some embodiments, and as a result the autonomous working robot loses a function. Therefore, the event is used as the sudden event, which helps to increase the possibility that the autonomous working robot moves safely.

In some embodiments, the slope detection in the environment in which the autonomous working robot is located being abnormal in the movement process includes that in the movement process, the autonomous working robot detects that the slope in the environment is greater than or equal to a slope threshold. For example, the autonomous working robot falls in a pit in the movement process, and in this case, the sudden case is triggered in some embodiments.

In the embodiments of this application, when the slope detection in the environment in which the autonomous working robot is located is abnormal in the movement process, in some embodiments, the autonomous working robot falls into a pit and cannot move. Therefore, the event is used as the sudden event, which helps to increase the possibility that the autonomous working robot moves safely.

In the embodiments of this application, after moving to the vehicle, the autonomous working robot needs to park in the vehicle. Correspondingly, a distance between the autonomous working robot and a carriage of the vehicle needs to be set to avoid a collision between the autonomous working robot and the carriage of the vehicle due to braking, acceleration, or another operation in a traveling process of the transport vehicle. Usually, the distance between the autonomous working robot and the carriage of the vehicle is set to be greater than or equal to 30 cm in some embodiments.

In some implementations, the sensing data further includes environmental data reflecting an environment in which the autonomous working robot is located. The controller is further configured to: provide the environmental data in the sensing data to a processing process, where the processing process is used for extracting environmental data related to a tail of the carriage from the environmental data; determine a distance between the autonomous working robot and the carriage of the vehicle according to the extracted environmental data; and if it is detected that the distance meets a preset distance range, output a stop instruction.

In some implementations, the distance between the autonomous working robot and the carriage of the vehicle includes a vertical distance between the autonomous working robot and the tail of the carriage of the vehicle in some embodiments. Certainly, the distance between the autonomous working robot and the carriage of the vehicle further includes a distance between the autonomous working robot and a head of the carriage of the vehicle in some embodiments. This is not limited in the embodiments of this application.

In addition, when a plurality of autonomous working robots need to be parked in the vehicle, to avoid a collision between adjacent autonomous working robots due to braking, acceleration, or another operation in the traveling process of the transport vehicle. Usually, the plurality of autonomous working robots are parked in a longitudinal direction (for example, parked in a head-to-tail direction of the carriage) in some embodiments, and a safe distance between adjacent autonomous working robots is set in some embodiments. Usually, the safe distance is set to be greater than or equal to 30 cm in some embodiments.

Embodiments of this application further provide an autonomous working robot, which can autonomously move between a target position and a starting position. In addition, in a process of the autonomous working robot in the embodiments of this application moving from the target position to the starting position, a movement path of the autonomous working robot is controlled based on the position data of one or more positions recorded in the process of the autonomous working robot moving from the starting position to the target position in some embodiments, thereby reducing the complexity of controlling the autonomous working robot.

FIG. 5 is a schematic diagram of an autonomous working robot according to another embodiment of this application. It needs to be noted that, the same numerals are used for elements with the same functions in the autonomous working robot shown in FIG. 5 and the autonomous working robot shown in FIG. 2. For details, refer to the foregoing description. For brevity, details are not described again.

Referring to FIG. 5, an autonomous working robot 500 includes a body 210, a driving assembly 220, a sensor assembly 230, and a controller 240 in some embodiments.

The driving assembly 220 is configured to drive the autonomous working robot to move according to a driving instruction.

The sensor assembly 230 is configured to generate sensing data based on acquired information. The sensing data includes positioning data used for indicating position information of the autonomous working robot.

The controller 240 is configured to: determine whether a first condition is met; in one embodiment, the controller 240 is electrically connected to the driving assembly and the sensor assembly.
perform a departure control process in response to the first condition being met, to control the autonomous working robot to go to the target position from a current starting position, at least one of the starting position and the target position being located outside the working area.

It is to be understood that for the first condition being met in this embodiment, refer to the foregoing embodiment in which the controller meets the entry condition. For example, the first condition being met is receiving an external first instruction; or the first condition being met is that the controller receives sensing data, determines, based on the sensing data, that the first condition is met, and autonomously generates a control signal to perform the departure control process. For the manner of determining whether the first condition is met, refer to the foregoing embodiment of the entry condition being met. Details are not described here again.

In this embodiment, an example in which the first condition is receiving the first instruction is used to describe the departure control process. In other embodiments, the departure control process performed by the controller after another first condition is met is approximately the same. Details are not described here again. The controller 240 is configured to: receive an input of a first instruction; perform a departure control process in response to the first instruction, to control the autonomous working robot to go to the target position from a current starting position, at least one of the starting position and the target position being located outside the working area. The departure control process includes: determining, according to the sensing data, whether a preset event occurs in the autonomous working robot.

If yes, position data of at least one position of the autonomous working robot in the movement process in response to the occurrence of the preset event is recorded according to the positioning data in the sensing data, and the position data includes starting position data used for indicating the position information of the starting position.

The controller 240 is further configured to determine whether a second condition is met; and perform a return control process in response to the second condition being met, to control the autonomous working robot to return from the target position to the starting position. The return control process includes: controlling the autonomous working robot according to the starting position data to pass through the at least one position to return to the starting position.

It is to be understood that for the second condition being met in this embodiment, refer to the foregoing embodiment in which the controller meets the return condition. For example, the second condition being met is receiving an external second instruction; or the second condition being met is that the controller receives sensing data, determines, based on the sensing data, that the second condition is met, and autonomously generates a control signal to perform the return control process. For the manner of determining whether the second condition is met, refer to the foregoing embodiment of the return condition being met. Details are not described here again.

In this embodiment, an example in which the second condition is receiving the second instruction is used to describe the return control process. In other embodiments, the return control process performed by the controller after another second condition is met is approximately the same. Details are not described here again. The controller 240 receives an input of a second instruction; and performs a return control process in response to the second instruction, to control the autonomous working robot to return from the target position to the starting position. The return control process includes: controlling the autonomous working robot according to the starting position data to pass through the at least one position to return to the starting position.

In some implementations, the at least one of the starting position and the target position being located outside the working area includes that one of the starting position and the target position is located in the non-working area in some embodiments. For example, referring to FIG. 3, the autonomous working robot moves from the non-working area 310 to the working area 330. In another example, the autonomous working robot moves from the working area 330 to the non-working area 310.

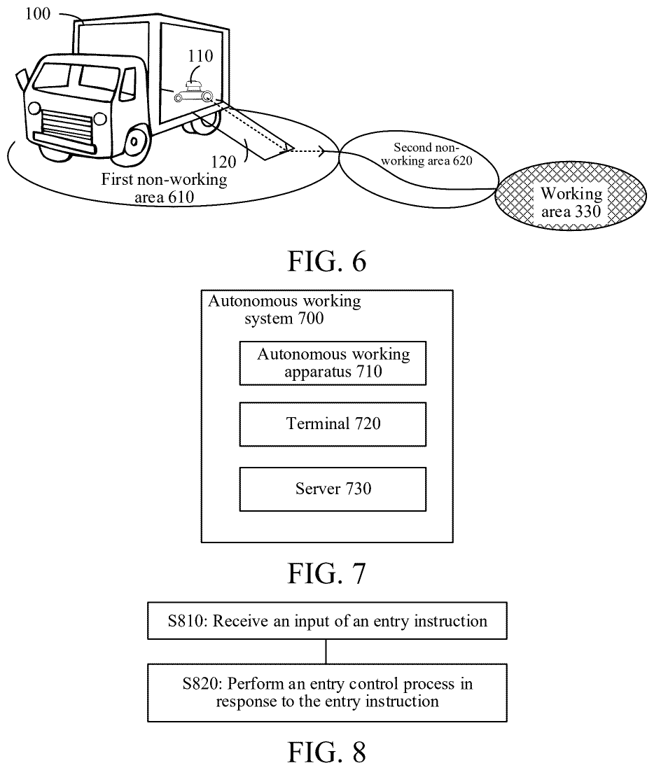

In some other implementations, the at least one of the starting position and the target position being located outside the working area includes that the starting position and the target position are both located in the non-working area in some embodiments. For example, referring to FIG. 6, the autonomous working robot moves from a first non-working area 610 in which the transport vehicle 100 is parked to a second non-working area 620 in some embodiments. In another example, the autonomous working robot moves from the second non-working area 620 to the first non-working area 610 in which the transport vehicle 100 is parked in some embodiments. In some other implementations, the transport vehicle 100 itself is used as the non-working area 310 or the first non-working area 610 in some embodiments.

It needs to be noted that, the position data indicates the autonomous working robot to enter a starting position, for example, the get-off point described above, of the second non-working area from the first non-working area in some embodiments. Correspondingly, the preset event in this implementation includes one or more events that can be used for marking an area in which the starting position is located, and is referred to as a second class preset event, which includes, for example, detecting that the autonomous working robot enters the second non-working area from the first non-working area in some embodiments in some embodiments.

In the embodiments of this application, in the process of the autonomous working robot moving from the starting position to the target position, the controller performs the departure control process, to record position data of the autonomous working robot in the movement process in response to the occurrence of a preset event, so that when the autonomous working robot moves back to the starting position from the target position, the controller performs the return control process to control the autonomous working robot to pass through a position corresponding to the position data to the starting position, thereby reducing the complexity of controlling the autonomous working robot to return from the target position to the starting position.

In some implementations, the second class preset event further includes at least one of the following in some embodiments: a position height change of the autonomous working robot in the movement process meets a preset condition; and the positioning data of the autonomous working robot in the movement process meets a preset precision condition.

The position height change of the autonomous working robot in the movement process meeting the preset condition includes that the position height change of the autonomous working robot in the movement process is greater than a height threshold in some embodiments. For example, when the autonomous working robot moves from a non-working area on a ground into the vehicle through a ramp, the position height change of the autonomous working robot in the movement process is greater than the height threshold. In another example, when the autonomous working robot moves from the vehicle to the non-working area on the ground through the ramp, the position height change of the autonomous working robot in the movement process is greater than the height threshold.

The positioning data of the autonomous working robot in the movement process meeting the preset precision condition includes, for example, that the convergence of an RTK signal is completed in some embodiments, or includes that precision of the positioning data of the autonomous working robot in the movement process is greater than a precision threshold in some embodiments. This is not limited in the embodiments of this application.

In some implementations, the sensor assembly includes a tilt sensor used for detecting a body tilt and a slope sensor used for detecting a slope of a surface in a movement direction of the autonomous working robot, and the sensing data includes tilt data and slope data. A determination process includes: determining, according to the tilt data and the slope data in the sensing data, whether the autonomous working robot moves from the starting position to the target position through the ramp. If a determination result is yes, position data of at least one position of the autonomous working robot after passing through the ramp is recorded according to the positioning data in the sensing data.

It needs to be noted that, the autonomous working robot 500 has functions similar to those of the autonomous working robot 200, for example, related functions of the prompt assembly 270, and related functions of the interaction assembly 250 in some embodiments. For brevity, details are not described again.

Embodiments of this application further provide an autonomous working system. FIG. 7 is a schematic diagram of an autonomous working system 700 according to an embodiment of this application. Referring to FIG. 7, the autonomous working system 700 includes an autonomous working robot 710, a terminal 720, and a server 730 in some embodiments.

The autonomous working robot 710 is any autonomous working robot described above in some embodiments.

The terminal 720 is communicatively connected to the autonomous working robot. The terminal 720 is also referred to as user equipment (UE), an access terminal, a mobile terminal, a user terminal, a wireless communication device, a user agent or a user apparatus in some embodiments. The terminal device in the embodiments of this application is a device that provides voice and/or data connectivity to a user, for example, a handheld device or an in-vehicle device that has a wireless connection function in some embodiments. The terminal device in the embodiments of this application is a mobile phone, a tablet computer (pad), a notebook computer, a handheld computer, a mobile internet device (MID), a wearable device, or the like in some embodiments.

The server 730 is communicatively connected to the autonomous working robot 710 and the terminal 720, and is configured to store map data of different working areas in some embodiments, to send the map data of the working areas to the autonomous working robot and/or the terminal in the entry control process. In some implementations, the server 730 is a cloud server in some embodiments.

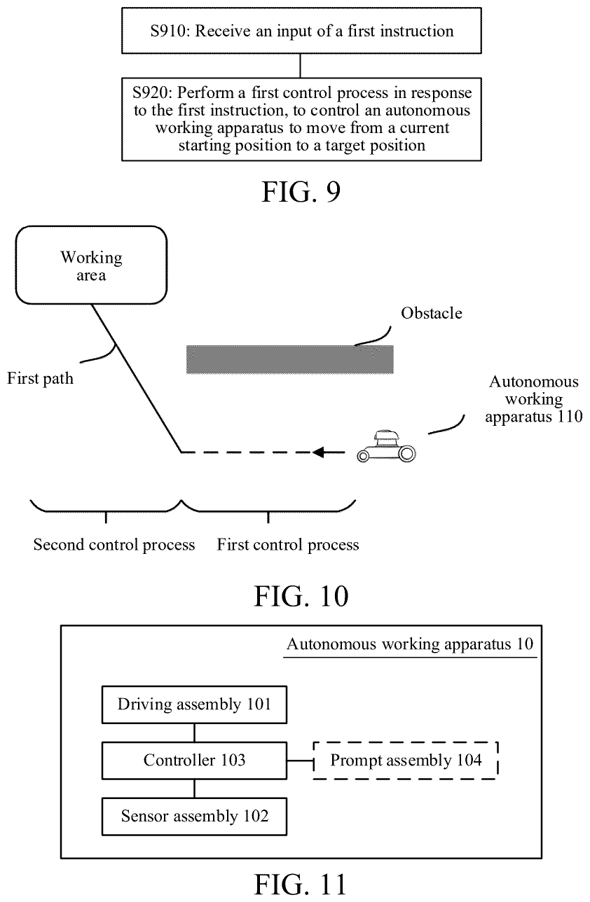

The apparatus embodiment of the present disclosure is described above in detail with reference to FIG. 1 to FIG. 7. The method embodiment of the present disclosure is described below in detail with reference to FIG. 8 and FIG. 9. It can be understood that the description of the method embodiment corresponds to the description of the apparatus embodiment. Therefore, for the part not described in detail, refer to the foregoing method embodiment. In addition, the method embodiment described below is implemented by any apparatus above in some embodiments.

FIG. 8 is a schematic diagram of a control method of an autonomous working robot according to an embodiment of this application. The method shown in FIG. 8 includes step S810 and step S820. It can be understood that the method shown in FIG. 8 is performed by a controller in the autonomous working robot in some embodiments.

Step S810: Receive an input of an entry instruction.

Step S820: Perform an entry control process in response to the entry instruction.

The entry control process includes: outputting a corresponding driving instruction according to the sensing data, to control a first movement trajectory of the autonomous working robot moving from a vehicle transporting the autonomous working robot to a ground of a non-working area; obtaining map data of a working area of a working task to be performed; and outputting a corresponding driving instruction according to the map data and sensing data, to control a second movement trajectory of the autonomous working robot moving from the ground of the non-working area to the working area.

In a possible implementation, the method further includes: receiving an input of a return instruction; and performing a return control process in response to the return instruction. The return control process includes: outputting a corresponding driving instruction according to the map data and sensing data, to control a third movement trajectory of the autonomous working robot moving from a working area to a ground of a non-working area; obtaining vehicle position data used for indicating position information of the vehicle; and outputting a corresponding driving instruction according to the vehicle position data and the sensing data, to control a fourth movement trajectory of the autonomous working robot moving from the ground of the non-working area to the vehicle.

In a possible implementation, the sensing data includes positioning data used for indicating position information of the autonomous working robot. The method further includes: providing the sensing data to a first determination process, where the first determination process is used for determining whether a preset event occurs in the autonomous working robot; if a determination result is yes, recording position data of at least one position of the autonomous working robot in the first movement trajectory and/or the second movement trajectory according to the positioning data in the sensing data in response to the occurrence of the preset event, where the position data includes the vehicle position data; and obtaining the position data, and controlling the autonomous working robot to pass through the at least one position to return to the vehicle.

In a possible implementation, the sensing data further includes environmental data reflecting an environment in which the autonomous working robot is located. The method further includes: providing the environmental data in the sensing data to a second determination process, where the second determination process is used for determining whether the autonomous working robot moves from the vehicle to the ground of the non-working area; and if a determination result is yes, recording, according to the positioning data in the sensing data, position data of at least one position after the autonomous working robot reaches the ground of the non-working area.

In a possible implementation, the sensor assembly includes a tilt sensor used for detecting a body tilt and a slope sensor used for detecting a slope of a surface in a movement direction of the autonomous working robot, and the sensing data includes tilt data and slope data. The second determination process includes: determining, according to the tilt data and the slope data in the sensing data, whether the autonomous working robot moves from the vehicle to the ground of the non-working area through a ramp.

In an implementation, the driving assembly is configured to drive the autonomous working robot with a first preset power to move on the ramp, where the autonomous working robot has a first movement speed; and the driving assembly is configured to drive the autonomous working robot with a second preset power to move and work in the working area, where the autonomous working robot has a second movement speed, where the first movement speed is less than the second movement speed.

In a possible implementation, the method further includes: providing the positioning data in the sensing data to a third determination process, where the third determination process is used for determining whether the positioning data meets a preset precision condition; and if a determination result is yes, recording, according to the positioning data in the sensing data, position data of at least one position of the autonomous working robot in the first movement trajectory and/or the second movement trajectory in response to the positioning data meets the preset precision condition.

In a possible implementation, the method further includes: if a determination result is yes, recording, according to the positioning data in the sensing data, first trajectory data of the first movement trajectory and second trajectory data of the second movement trajectory in response to the positioning data meets the preset precision condition; controlling the third movement trajectory of the autonomous working robot according to the second trajectory data and the sensing data; and controlling the fourth movement trajectory of the autonomous working robot according to the first trajectory data and the sensing data.

In a possible implementation, the autonomous working robot further includes a working assembly, electrically connected to the controller. The method further includes: in a process of performing the entry control process and the return control process, controlling the autonomous working robot to stop the working assembly.

In a possible implementation, the sensing data includes positioning data used for indicating position information of the autonomous working robot and environmental data reflecting an environment in which the autonomous working robot is located. The method further includes: providing the environmental data in the sensing data to a fourth determination process, where the fourth determination process is used for determining whether the autonomous working robot moves from the ground of the non-working area to the working area; and if a determination result is yes, recording, according to the positioning data in the sensing data, position data of a position of the autonomous working robot when the autonomous working robot reaches the working area, where the recorded position data is used for indicating the standby position of the autonomous working robot.

In a possible implementation, the autonomous working robot further includes an interaction assembly, electrically connected to the controller, and configured to perform information interaction with a user. The method further includes: after it is detected that a current working task is completed, controlling the autonomous working robot to stop the working assembly and return to the standby position; controlling the interaction assembly to display information used for indicating to select to return/continue to perform at least one working task; receiving an input of confirmation information about the selection to return/continue to perform at least one working task; and outputting a corresponding instruction, to control the autonomous working robot to return/continue to perform at least one working task.

In a possible implementation, the method further includes: when it is detected that the autonomous working robot arrives at the working area, controlling the autonomous working robot to stay at the standby position; controlling the interaction assembly to display working parameter information corresponding to the working area; receiving an input of confirmation information about the working parameter information by a user; and outputting a corresponding instruction, to control the autonomous working robot to turn on the working assembly and start to perform at least one working task.

In a possible implementation, the sensing data further includes environmental data reflecting an environment in which the autonomous working robot is located. The method further includes: providing the environmental data in the sensing data to a processing process, where the processing process is used for extracting environmental data related to a ramp from the environmental data; determining a distance between the autonomous working robot and an edge of the ramp according to the extracted environmental data; and outputting a corresponding driving instruction according to the distance to control a movement trajectory of the autonomous working robot passing through the ramp.

In a possible implementation, the sensing data further includes environmental data reflecting an environment in which the autonomous working robot is located. The autonomous working robot further includes a prompt assembly, electrically connected to the controller, and configured to send out a prompt signal according to a prompt instruction. The method further includes: providing the environmental data in the sensing data to a fifth determination process, where the fifth determination process is used for determining whether the autonomous working robot encounters a sudden event; if a determination result is yes, outputting a prompt instruction to the prompt assembly; and outputting a braking instruction to the driving assembly to control the autonomous working robot to brake.

In a possible implementation, the sudden event includes at least one of the following event: feature detection related to the vehicle is abnormal before the apparatus gets on the vehicle; distance detection for deviation from a predetermined movement route is abnormal in an obstacle avoidance process; and slope detection in an environment in which the autonomous working robot is located is abnormal in a movement process.

In a possible implementation, the sensing data further includes environmental data reflecting an environment in which the autonomous working robot is located. The method further includes: providing the environmental data in the sensing data to a processing process, where the processing process is used for extracting environmental data related to a tail of the carriage from the environmental data; determining a vertical distance between the autonomous working robot and a tail of the vehicle according to the extracted environmental data; and if it is detected that the distance meets a preset distance range, output a stop instruction.

In an implementation, the sensor assembly includes at least one of a positioning sensor, a monocular camera, a multiocular camera, a depth camera, an ultrasonic sensor, and an inertial measurement unit.

In a possible implementation, the autonomous working robot includes at least one of an autonomous lawn mower, an autonomous snowplow, an autonomous irrigation machine, or an autonomous vacuum cleaner.

FIG. 9 is a schematic diagram of a control method of an autonomous working robot according to another embodiment of this application. The method shown in FIG. 9 includes step S910 and step S920. It can be understood that the method shown in FIG. 9 is performed by a controller in the autonomous working robot in some embodiments.

Step S910: Receive an input of a first instruction.

Step S920: Perform a departure control process in response to the first instruction, to control the autonomous working robot to go to the target position from a current starting position, at least one of the starting position and the target position being located outside the working area.

The departure control process includes: determining, according to the sensing data, whether a preset event occurs in the autonomous working robot, if yes, recording position data of at least one position of the autonomous working robot in the movement process in response to the occurrence of the preset event according to the positioning data in the sensing data, where the position data includes starting position data used for indicating the position information of the starting position; receiving an input of a second instruction; and performing a return control process in response to the second instruction, to control the autonomous working robot to return from the target position to the starting position. The return control process includes: controlling the autonomous working robot according to the starting position data to pass through the at least one position to return to the starting position.

In a possible implementation, the preset event includes at least one of the following: a position height change of the autonomous working robot in the movement process meets a preset condition; and the positioning data of the autonomous working robot in the movement process meets a preset precision condition. The autonomous working robot moves from the ground of the non-working area to the working area/moves from the working area to the ground of the non-working area.

In a possible implementation, the sensor assembly includes a tilt sensor used for detecting a body tilt and a slope sensor used for detecting a slope of a surface in a movement direction of the autonomous working robot, and the sensing data includes tilt data and slope data. The determination process includes: determining, according to the tilt data and the slope data in the sensing data, whether the autonomous working robot moves from the starting position to the target position through the ramp. If a determination result is yes, position data of at least one position of the autonomous working robot after passing through the ramp is recorded according to the positioning data in the sensing data.

Generally, in some embodiments, the autonomous working robot performs one or more working tasks in the working area. For example, in some embodiments, when being an autonomous lawn mower, the autonomous working robot performs a mowing task in the working area, or performs a charging task or another task in the working area. In another example, in some embodiments, when being an autonomous snowplow, the autonomous working robot performs a snow removal task in the working area. In still another example, in some embodiments, when being an autonomous irrigation machine, the autonomous working robot performs an irrigation task in the working area, and the like.

In some embodiments, the autonomous working robot performs a working task in one or more working areas. For example, in some embodiments, within a time range (for example, within one day), the autonomous working robot first goes to a first working area to perform a task of the first working area, and continues to go to a second working area to perform a working task of the second working area after completing the task of the first working area, and so on.

It can be understood that working tasks performed by the autonomous working robot in a plurality of working areas are the same or different in some embodiments. For example, the autonomous working robot is an autonomous lawn mower. In some embodiments, after going to the first working area to perform a mowing task, the autonomous working robot goes to the second working area to perform a mowing task, or goes to the second working area to perform a charging task, or the like.

In consideration of safety, at present, the autonomous working robot can only implement automatic movement while performing a working task in a working area. For the movement of the autonomous working robot between the outside of the working area and the arrival at the working area, manual operations are required, which is time and labor consuming.

For example, the autonomous working robot is an autonomous lawn mower. An existing autonomous lawn mower usually performs a mowing task while automatically moving in a manually defined to-be-mowed area (working area). A manual operation manner (for example, manual operation and traveling or manual carrying) is used outside the to-be-mowed area to make the autonomous lawn mower move to a boundary or into the to-be-mowed area. Especially, a commercial lawn mower (for example, a riding lawn mower) can basically only be manually operated to travel to the to-be-mowed area. The reason is that the commercial lawn mower is usually a large lawn mower used by a commercial team lawn mowing company and has both a large size and a heavy weight, making it nearly impossible to manually carry the lawn mower to the to-be-mowed area. It inevitably requires extra labor to use a manual operation and driving manner to make the commercial lawn mower to move to a working area.

In addition, a working mode of the commercial team lawn mowing company is going to different users' homes according to scheduled orders to perform lawn maintenance, including mowing, trimming, green plant pruning, among various other work. In addition, the various work is completed by different devices or manually by a worker. In this case, it interferes with the working time of the team to manually operate and drive the commercial lawn mower to the working area, which affects the working efficiency of the team.

To resolve the foregoing problems, embodiments of the present disclosure provide an autonomous working robot, a control method, and an autonomous working system. The embodiments of the present disclosure are described below in detail with reference to the accompanying drawings.

According to a first aspect, embodiments of the present disclosure provide an autonomous working robot. FIG. 11 is a schematic structural diagram of an autonomous working robot 10 according to an embodiment of the present disclosure. As shown in FIG. 11, in some embodiments, the autonomous working robot 10 includes a driving assembly 101, a sensor assembly 102, and a controller 103. These assemblies (or components) included in the autonomous working robot 10 are separately described below.

In some embodiments, the driving assembly 101 is configured to drive the autonomous working robot 10 to move according to a driving instruction. For example, in some embodiments, the driving assembly 101 drives the autonomous working robot 10 to move inside the working area or move outside the working area.

In some embodiments, the driving assembly 101 includes an electric machine, a motor, or the like, and is configured to provide a driving power.

In some embodiments, the driving assembly 101 further includes a movement component. As an implementation, in some embodiments, that the driving assembly 101 drives the autonomous working robot 10 to move according to the driving instruction is that the driving assembly 101 drives the movement component to move according to the driving instruction, to drive the autonomous working robot 10 to move.

In some embodiments, the movement component is mounted at the bottom of the autonomous working robot 10. In some embodiments, the movement component is also referred to as a traveling component, a movement mechanism, a movement assembly, or the like. This is not limited in the embodiments of the present disclosure.

In some embodiments, the movement component is, for example, a wheel body, and for example, includes a universal wheel, a driving wheel, or the like. When including a universal wheel, the movement component is used for changing an advancing direction of the autonomous working robot 10 in some embodiments. In some embodiments, the universal wheel is, for example, mounted at a front end (a front end of the autonomous working robot 10 in the traveling direction) of the bottom of the autonomous working robot 10. When including a driving wheel, the movement component is used for driving the autonomous working robot 10 to move in some embodiments. In some embodiments, the driving wheel is, for example, mounted at a lateral position of the bottom of the autonomous working robot 10.

In some embodiments, the sensor assembly 102 is used for acquiring information, for example, acquiring position information of the autonomous working robot 10, environmental information (for example, ground environment information of a ground on which the autonomous working robot 10 is located) of an environment in which the autonomous working robot 10 is located, and the like. In some embodiments, various types of sensor assemblies 102 are included, and are not limited in the embodiments of the present disclosure. In some embodiments, for example, the sensor assembly 102 includes, but is not limited to, an ultrasonic sensor, an infrared sensor, a visual sensor, a laser sensor, an image sensor, a satellite positioning sensor, and the like.

In some embodiments, the sensor assembly 102 acquires information in various manners. In some embodiments, the sensor assembly 102 is used for emitting a signal around the autonomous working robot 10, to obtain, according to a reflected signal of the emitted signal, the environmental information of the environment in which the autonomous working robot 10 is located. When information is acquired in this manner, the sensor assembly 102 includes, for example, an ultrasonic sensor, an infrared sensor, a laser sensor, and the like in some embodiments. In some embodiments, the sensor assembly 102 obtains, in an image sensing manner, the environmental information of the environment in which the autonomous working robot 10 is located. When information is acquired in this manner, the sensor assembly 102 includes, for example, a visual sensor, an image sensor, and the like in some embodiments. In some embodiments, the sensor assembly 102 obtains, in a satellite positioning manner, the position information of the autonomous working robot 10. When information is acquired in this manner, the sensor assembly 102 includes, for example, a satellite positioning sensor.

In some embodiments, the sensor assembly 102 is further configured to generate sensing data based on the acquired information, so that the controller 103 controls the autonomous working robot 10 according to the generated sensing data.

In some embodiments, the sensing data includes, for example, positioning data used for indicating the position information of the autonomous working robot 10. The positioning data is generated by the sensor assembly 102 based on the acquired position information of the autonomous working robot 10. In some embodiments, the sensing data further includes, for example, environmental data indicating the environment in which the autonomous working robot 10 is located. The environmental data is generated by the sensor assembly 102 based on the acquired environmental information of the environment in which the autonomous working robot 10 is located.

In some embodiments, the position information of the autonomous working robot 10 is pose information of the autonomous working robot 10, which includes position coordinates of the autonomous working robot 10 and a heading angle of the autonomous working robot 10.

In some embodiments, the sensor assembly 102 determines the position information of the autonomous working robot 10 after a positioning signal converges. As an implementation, if only one antenna is disposed on the autonomous working robot 10, the position coordinates of the autonomous working robot 10 are determined after the positioning signal converges, and the heading angle can be determined only after the autonomous working robot 10 has moved by a specific distance (for example, moved forward by 1 to 2 meters). As another implementation, if two or more antennas are disposed on the autonomous working robot 10, the position coordinates and the heading angle (i.e., the position information) of the autonomous working robot 10 are determined after the positioning signal converges in some embodiments.

A manner of obtaining the positioning data is not limited in the embodiments of the present disclosure. For example, in some embodiments, the positioning data is obtained by using one or more of the following measurement technologies: a GSP technology, a visual simultaneous localization and mapping (Visual Simultaneous Localization And Mapping, VSLAM) technology, an inertial measurement unit (Inertial Measurement Unit, IMU) technology, a real-time kinematic (Real-Time Kinematic, RTK) positioning technology, and a network real-time kinematic (network RTK, NRTK) positioning technology.

As a specific example, in some embodiments, the positioning data is obtained through positioning by using a GPS technology. As another specific example, in some embodiments, the positioning data is obtained through positioning by fusing a GPS technology, a VSLAM technology, and an IMU technology. As still another specific example, in some embodiments, the positioning data is obtained through high-precision positioning by using am RTK technology or an NRTK technology.

The controller 103 is communicatively connected to the driving assembly 101 and the sensor assembly 102. It can be understood that the communicative connection mentioned in the embodiments of the present disclosure may be understood in a broad sense. In other words, in some embodiments, various specific connection manners are included, provided that communication can be implemented between the controller 103 and the driving assembly 101 or between the controller 103 and the sensor assembly 102. For example, in some embodiments, the connection between the controller 103 and the driving assembly 101 or the sensor assembly 102 is a fixed connection or a detachable connection; or is a mechanical connection or an electrical connection; or is a direct connection, an indirect connection through an intermediary, internal communication between components, or the like.

In some embodiments, a connection manner between the controller 103 and the driving assembly 101 and a connection manner between the controller 103 and the sensor assembly 102 are the same, for example, are both electrical connections. In some embodiments, a connection manner between the controller 103 and the driving assembly 101 and a connection manner between the controller 103 and the sensor assembly 102 are different. For example, in some embodiments, the controller 103 and the driving assembly 101 are mechanically connected, and the controller 103 and the sensor assembly 102 are electrically connected.

In the embodiments of the present disclosure, the controller 103 at least performs one control process, for example, a process of controlling the autonomous working robot 10 to move in some embodiments. In the control process, the controller 103 receives sensing data (i.e., receive an input of the sensing data, for example, receive an input of the positioning data) sent by the sensor assembly 102, and controls, according to the sensing data, movement of the autonomous working robot 10 outside the working area in some embodiments. In the control process, the controller 103 further at least performs a navigation process in some embodiments, to control, based on the navigation process, the autonomous working robot 10 to move from outside the working area to a boundary of the working area or into the working area. The navigation process performed by the controller 103 is described below.

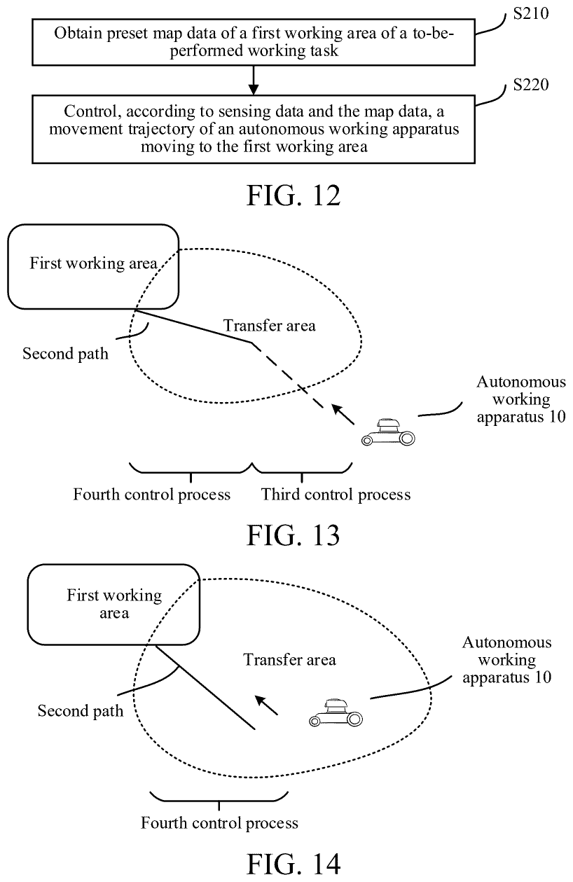

Referring to FIG. 12, the navigation process performed by the controller 103 includes Step S210 and Step S220 in some embodiments.

Step S210: Obtain preset map data of a working area (which is also referred to as a first working area or a working area that currently requires entry to work in some embodiments) of a working task to be performed.

Step S220: Control, according to sensing data and the map data, a movement trajectory of an autonomous working robot moving to the working area. The map data includes boundary data of the working area and guidance data used for guiding the autonomous working robot to move to the working area.

Further, the guidance data includes first path data, the first path data is used for indicating a pre-established first path to the working area, and a path starting point of the first path is located outside the working area.

Furthermore, the controller is configured to: according to the sensing data and the first path data, control a movement trajectory of the autonomous working robot moving outside the working area to the path starting point of the first path, and control a movement trajectory of the autonomous working robot moving to the working area along the first path.

In an embodiment, the guidance data includes boundary data of a transfer area, the transfer area is in communication with the working area, and the controlling, according to sensing data and the map data, a movement trajectory of an autonomous working robot moving to the working area includes: controlling, according to the sensing data and the boundary data, a movement trajectory of the autonomous working robot passing through the transfer area to move to the working area.

Further, the controller is configured to: obtain second path data, where the second path data is used for indicating a second path from the transfer area to the working area, and a path starting point of the second path is located outside the working area; and control, according to the sensing data and the second path data, a movement trajectory of the autonomous working robot moving from the transfer area to the working area; or control, according to the sensing data and the boundary data of the transfer area, a movement trajectory of the autonomous working robot moving from outside the transfer area to the transfer area, and control, according to the sensing data and the second path data, a movement trajectory of the autonomous working robot moving from the transfer area to the working area.

Furthermore, the second path is the shortest path planned by the autonomous working robot based on the positioning data and the boundary data of the working area; or the second path is a preset path.

In an embodiment, the map data is generated in advance based on coordinate information acquired by an apparatus with a positioning assembly, and the coordinate information includes one or more of the following information:
coordinate information of the boundary of the working area;
coordinate information of the first path to the working area; and
coordinate information of a boundary of the transfer area in communication with the working area.

In an embodiment, the map data of the working area is obtained from a set of map data of working areas that meet a predetermined condition. The working area that meets the predetermined condition represents a working area with a distance from the autonomous working robot being less than or equal to a first distance threshold.

In an embodiment, the map data of the working area is obtained according to one or more of the following manners:
retrieving the map data of the working area from a set of prestored map data of different working areas according to positioning data of the autonomous working robot;
retrieving the map data of the working area from a set of prestored map data of different working areas according to preset scheduling data of the autonomous working robot; and
receiving the map data of the working area sent by a server based on scheduling of the autonomous working robot.

In an embodiment, the controller is further configured to: in a process of controlling the autonomous working robot to move toward the path starting point of the first path, detect a distance between the autonomous working robot and the path starting point of the first path according to the positioning data and the first path data; provide the distance to a determination process, where the determination process is used for determining whether the distance is greater than a second distance threshold; and if a determination result is yes, control, based on an operation instruction inputted by a user, the autonomous working robot to move to the starting point of the first path.

In an embodiment, the controller is further configured to: in a process of controlling the autonomous working robot to move toward the transfer area, detect the distance between the autonomous working robot and any position on the boundary of the transfer area according to the positioning data and the boundary data of the transfer area; provide the distance to a determination process, where the determination process is used for determining whether the distance is greater than a third distance threshold; and if a determination result is yes, control, based on an operation instruction inputted by a user, the autonomous working robot to move to the transfer area.

In an embodiment, the sensing data further includes environmental data reflecting an environment in which the autonomous working robot is located; the autonomous working robot further includes a prompt assembly, electrically connected to the controller, and configured to send a prompt signal according to a prompt instruction; and the controller is further configured to: provide the environmental data in the sensing data to a determination process, where the determination process is used for determining whether the autonomous working robot encounters an obstacle in a process of moving toward the working area along the first path; if a determination result is yes, output a prompt instruction to the prompt assembly; and output a braking instruction to the driving assembly to control the autonomous working robot to brake.

In an embodiment, the sensing data further includes environmental data used for indicating an environment in which the autonomous working robot is located; and the controller is further configured to: provide the environmental data in the sensing data to a determination process. The determination process is used for determining whether the autonomous working robot encounters an obstacle/a ground pit in a process of moving toward the path starting point of the first path; and if a determination result is yes, control the autonomous working robot to move around the obstacle/ground pit.

Further, the autonomous working robot further includes a prompt assembly, electrically connected to the controller, and configured to send a prompt signal according to a prompt instruction; and the controller is configured to: detect a deviation distance when the autonomous working robot moves around the obstacle/ground pit, where the deviation distance means a vertical distance by which the autonomous working robot deviates from a connecting line between a movement starting point thereof and the path starting point of the first path; provide deviation distance data to a determination process, where the determination process is used for determining whether the deviation distance exceeds a predetermined range; if a determination result is yes, output a prompt instruction to the prompt assembly; and output a braking instruction to the driving assembly to control the autonomous working robot to brake. In an embodiment, the driving assembly is configured to drive the autonomous working robot with a first preset power to move outside the working area, and the autonomous working robot has a first movement speed; and the driving assembly is configured to drive the autonomous working robot with a second preset power to move and work in the working area, and the autonomous working robot has a second movement speed. The first movement speed is less than the second movement speed.

In an embodiment, the positioning data is obtained by using one or more of the following measurement technologies: a GSP technology, a visual simultaneous localization and mapping technology, an inertial measurement unit technology, a real-time kinematic positioning technology, and a network real-time kinematic positioning technology.

In an embodiment, the autonomous working robot is at least one of an autonomous lawn mower, an autonomous snowplow, an autonomous irrigation machine, or an autonomous vacuum cleaner.

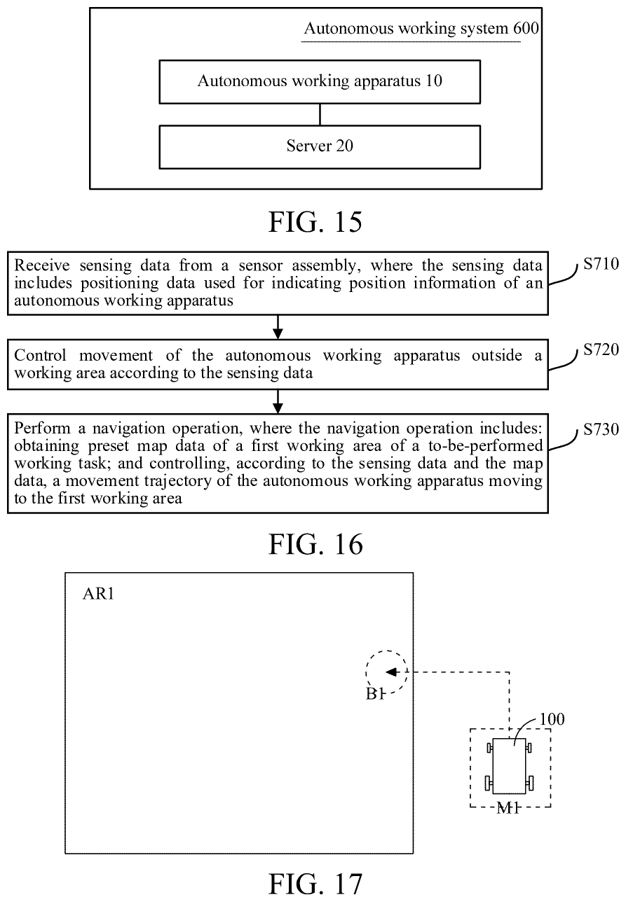

According to a second aspect, embodiments of the present disclosure provide an autonomous working system. A schematic structural diagram of the autonomous working system is shown in FIG. 15. An autonomous working system 600 shown in FIG. 15 includes an autonomous working robot 10 and a server 20 in some embodiments.

The autonomous working robot included in the autonomous working system 600 is any autonomous working robot described above in some embodiments.

The server 20 is configured to provide map data of a working area to the autonomous working robot in some embodiments. For example, the server 20 only provides the map data of the working area to the autonomous working robot in some embodiments. Alternatively, in some embodiments, the server 20 provides a set of map data of working areas that meet a predetermined condition to the autonomous working robot, and the map data of the working area is invoked from the set of map data by the autonomous working robot or manually.

In some embodiments, the autonomous working system 600 further includes a terminal. In some embodiments, the terminal is configured to: receive the set of map data of working areas that meet the predetermined condition sent by the server 20, and determine the map data of the working area from the set. In this case, in some embodiments, the server 20 is configured to provide the map data of the working area to the autonomous working robot according to the map data of the working area determined by the terminal.

The method embodiments of the present disclosure are described in detail with reference to FIG. 16. It can be understood that the description of the method embodiment corresponds to the description of the apparatus embodiment. Therefore, for the part not described in detail, refer to the foregoing apparatus embodiment.

FIG. 16 is a schematic flowchart of a control method of an autonomous working robot according to an embodiment of the present disclosure. In some embodiments, the autonomous working robot is any autonomous working robot described above. In some embodiments, the method shown in FIG. 16 is performed by a controller of the autonomous working robot. In some embodiments, the method includes step S710 to step S730.

Step S710: Receive sensing data from a sensor assembly, where the sensing data includes positioning data used for indicating position information of the autonomous working robot.

Step S720: Control movement of the autonomous working robot outside a working area according to the sensing data.

Step S730: Perform a navigation operation. In some embodiments, the navigation operation includes the following steps:
obtaining preset map data of a working area (which is also referred to as a first working area or a working area that currently requires entry to work in some embodiments) of a working task to be performed, where the map data includes boundary data of the working area and guidance data used for guiding the autonomous working robot to move to the working area; and controlling, according to the sensing data and the map data, a movement trajectory of the autonomous working robot moving to the working area.

It needs to be noted that a route of transferring the autonomous working robot to the working area by a transport vehicle in the foregoing embodiment includes a route of entering the working area from outside the working area. For detailed description of the entering the working area from outside the working area in this embodiment, refer to the foregoing embodiments. Details are not described again in this embodiment. It can be understood that in the embodiments of the present disclosure, the controller includes a processor in some embodiments. In some embodiments, the processor uses a general central processing unit (CPU), a microprocessor, an application-specific integrated circuit (ASIC), or one or more integrated circuits, and is configured to execute a related program to implement the technical solutions provided in the embodiments of the present disclosure.

In some embodiments, the storage apparatus (also referred to as a memory) in the embodiments of this application includes a read-only memory and a random access memory, and provides instructions and data to the processor. A part of the processor further includes a nonvolatile random access memory in some embodiments. For example, the processor further stores information of a device type in some embodiments.

In an implementation process, steps of the foregoing method are implemented by using an integrated logic circuit of hardware in the controller, or by using instructions in a form of software in some embodiments. In some embodiments, the method for controlling an autonomous working robot disclosed with reference to the embodiments of the present disclosure is directly performed and completed by using a hardware processor, or is performed and completed by using a combination of hardware and software modules in the processor. In some embodiments, the software module is stored in a storage medium that is mature in the art, such as a random access memory (RAM), a flash memory, a read-only memory (ROM), a programmable ROM, an electrically erasable programmable memory, or a register. The storage medium is located in the memory. The controller reads information in the memory and completes the steps of the methods in combination with hardware thereof. To avoid repetition, details are not described herein again.

It can be understood that, in the embodiments of the present disclosure, the processor may be a central processing unit (CPU), or the processor may be another general purpose processor, a digital signal processor (DSP), an application-specific integrated circuit (ASIC), a field programmable gate array (FPGA), or another programmable logic device, discrete gate or transistor logic device, discrete hardware component, or the like. The general-purpose processor may be a microprocessor, or the processor may be any conventional processor or the like.

It can be understood that in the embodiments of the present disclosure, “B corresponding to A” represents that B is associated with A, and B may be determined according to A. However, it can further be understood that the determining B according to A does not mean determining B according to A only, and B may be determined according to A and/or other information.

It can be understood that the term “and/or” used in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It can be understood that sequence numbers of the foregoing processes do not mean execution sequences in the embodiments of the present disclosure. The execution sequences of the processes may be determined based on functions and internal logic of the processes, and may not constitute any limitation on implementation processes of the embodiments of the present disclosure.

In the several embodiments provided in the present disclosure, it can be understood that the disclosed system, apparatus, and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, the procedure or functions according to embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium readable by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD), a semiconductor medium (for example, a solid state disk (SSD)).

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the scope of protection of the present disclosure shall be subject to the scope of protection of the claims.

What is claimed is:

1. An autonomous working robot comprising:
a body;
a driving assembly connected to the body and configured to drive the autonomous working robot to move according to a driving instruction;
a sensor assembly configured to generate sensing data based on acquired information; and
a controller configured to:
determine whether an entry condition is met; and
perform an entry control process in response to the entry condition being met, the entry control process including:
outputting a first corresponding driving instruction according to the sensing data to control a first movement trajectory of the autonomous working robot moving from a vehicle transporting the autonomous working robot to a ground of a non-working area;
obtaining map data of a working area of a working task to be performed; and
outputting a second corresponding driving instruction according to the map data and sensing data to control a second movement trajectory of the autonomous working robot moving from the ground of the non-working area to the working area.

2. The autonomous working robot according to claim 1, wherein the entry condition comprises at least one of following:
the controller receives an input of an entry instruction;
the autonomous working robot recognizes that a position thereof is in a preset area; and
the autonomous working robot detects that a ramp of the vehicle is lowered.

3. The autonomous working robot according to claim 1, wherein the controller is further configured to:
determine whether a return condition is met; and
perform a return control process in response to the return condition being met, the return control process including:
outputting a third corresponding driving instruction according to the map data and sensing data to control a third movement trajectory of the autonomous working robot moving from the working area to the ground of the non-working area; and
obtaining position data of the vehicle; and
outputting a fourth corresponding driving instruction according to the position data of the vehicle and the sensing data, to control a fourth movement trajectory of the autonomous working robot moving from the ground of the non-working area to the vehicle.

4. The autonomous working robot according to claim 3, wherein the return condition comprises at least one of following:
the controller receives an input of a return instruction, and
the autonomous working robot completes the working task of the working area and parks at a preset parking position.

5. The autonomous working robot according to claim 3, wherein:
the sensing data comprises positioning data used for indicating position information of the autonomous working robot; and
the controller is further configured to:
provide the sensing data to a first determination process, the first determination process being used for determining whether a preset event occurs in the autonomous working robot;
in response to determining that the preset event occurs in the autonomous working robot, record position data of at least one position of the autonomous working robot in the first movement trajectory and/or the second movement trajectory according to the positioning data in the sensing data in response to an occurrence of the preset event, the position data including the vehicle position data; and
obtaining the position data, and controlling the autonomous working robot to pass through the at least one position to return to the vehicle.

6. The autonomous working robot according to claim 5, wherein:
the preset event comprises more than one event that can be used for marking where a vehicle position is located; and
the preset event comprises at least one of following:
detecting that the autonomous working robot moves to a get-off point;
detecting that the autonomous working robot moves to course confirmation position; and
detecting that the positioning data of the autonomous working robot meets a preset precision condition.

7. The autonomous working robot according to claim 5, wherein:
the sensing data further comprises environmental data reflecting an environment in which the autonomous working robot is located; and
the controller is further configured to:
provide the environmental data to a second determination process, the second determination process being used for determining whether the autonomous working robot moves from the vehicle to the ground of the non-working area; and
in response to determining that the autonomous working robot moves from the vehicle to the ground of the non-working area, record, according to the positioning data in the sensing data, position data of at least one position after the autonomous working robot reaches the ground of the non-working area.

8. The autonomous working robot according to claim 7, wherein:
the sensor assembly comprises:
a tilt sensor used for detecting a body tilt; and
a slope sensor used for detecting a slope of a surface in a movement direction of the autonomous working robot;
the sensing data further comprises tilt data and slope data; and
the second determination process comprises determining, according to the tilt data and the slope data, whether the autonomous working robot moves from the vehicle to the ground of the non-working area through a ramp.

9. The autonomous working robot according to claim 5, wherein the controller is further configured to:
provide the positioning data to a third determination process, wherein the third determination process is used for determining whether the positioning data meets a preset precision condition; and
in response to determining that the positioning data meets the preset precision condition, record, according to the positioning data in the sensing data, position data of at least one position of the autonomous working robot in the first movement trajectory and/or the second movement trajectory in response to the positioning data meets the preset precision condition.

10. The autonomous working robot according to claim 9, wherein:
the positioning data comprises satellite positioning data; and
the third determination process is used for determining whether the satellite positioning data meets the preset precision condition.

11. The autonomous working robot according to claim 9, wherein the controller is further configured to:
in response to determining that the positioning data meets the preset precision condition, record, according to the positioning data in the sensing data, first trajectory data of the first movement trajectory and second trajectory data of the second movement trajectory in response to the positioning data meets the preset precision condition;
control the third movement trajectory of the autonomous working robot according to the second trajectory data and the sensing data; and
control the fourth movement trajectory of the autonomous working robot according to the first trajectory data and the sensing data.

12. The autonomous working robot according to claim 1, wherein:
the sensing data comprises positioning data used for indicating position information of the autonomous working robot; and
the map data comprises boundary data of the working area and guidance data used for guiding the autonomous working robot to move to the working area.

13. The autonomous working robot according to claim 12, wherein:
the guidance data comprises first path data;
the first path data is used for indicating a pre-established first path to the working area; and
a starting point of the first path is located outside the working area.

14. The autonomous working robot according to claim 13, wherein the controller is further configured to:
according to the sensing data and the first path data, control a movement trajectory of the autonomous working robot moving outside the working area to a point on the first path, and control a movement trajectory of the autonomous working robot moving to the working area along the first path.

15. The autonomous working robot according to claim 14, wherein the controller is further configured to:
in a process of controlling the autonomous working robot to move toward the starting point of the first path, detect a distance between the autonomous working robot and the starting point of the first path according to the positioning data and the first path data;
provide the distance to a determination process, wherein the determination process is used for determining whether the distance is greater than a second distance threshold; and
in response to determining that the distance is greater than the second distance threshold, control, based on a received operation instruction, the autonomous working robot to move to the starting point of the first path.

16. The autonomous working robot according to claim 12, wherein the driving assembly is configured to:
drive the autonomous working robot with a first preset power to move outside the working area at a first movement speed; and
drive the autonomous working robot with a second preset power to move and work in the working area at a second movement speed, the first movement speed being less than the second movement speed.

17. The autonomous working robot according to claim 1, wherein:
the autonomous working robot is configured to perform at least one working task in the working area; and
the controller is further configured to:
obtain at least one working parameter of the autonomous working robot when performing a current working task;
determine, according to the at least one working parameter, whether the autonomous working robot needs to return to a preset parking position located outside the working area;
in response to determining that the autonomous working robot needs to return to the preset parking position located outside the working area, control the autonomous working robot to travel to a preset position to wait for a user operation to be applied, wherein the preset parking position is different from the preset position; and
make, based on the user operation, the autonomous working robot to return to the preset parking position, and switch to a state of waiting to perform a next working task or shut down.

18. The autonomous working robot according to claim 17, wherein position data of the preset position comprises position data of an entry position through which the autonomous working robot enters the working area.

19. The autonomous working robot according to claim 3, wherein:
the sensing data further comprises environmental data reflecting an environment in which the autonomous working robot is located; and
the controller is further configured to:
provide the environmental data to a processing process, the processing process being used for extracting environmental data related to a ramp from the environmental data;
determine a distance between the autonomous working robot and an edge of the ramp according to the environmental data; and
output a corresponding driving instruction according to the distance to control a movement trajectory of the autonomous working robot passing through the ramp.

20. An autonomous working system comprising:
an autonomous working robot;
a terminal communicatively connected to the autonomous working robot; and
a server communicatively connected to the autonomous working robot and the terminal, and configured to store map data of different working areas, to send the map data of the different working areas to the autonomous working robot and/or the terminal in an entry control process.
